(19) United States
(12) Patent Application Publication
(10) Pub. No.: US 2016/0035237 A1
(43) Pub. Date: Feb. 4, 2016

(54) SYSTEMS AND METHODS FOR PROVIDING A PERSONALIZED EDUCATIONAL PLATFORM

(71) Applicant: Fishtree Ltd., Dublin 9 (IE)

(72) Inventors: Terry Nealon, Greystones (IE); Jim Butler, Johnstown (IE)

(21) Appl. No.: 14/818,581

(22) Filed: Aug. 5, 2015

Related U.S. Application Data
(63) Continuation of application No. 13/939,897, filed on Jul. 11, 2013.
(60) Provisional application No. 61/670,296, filed on Jul. 11, 2012.

(51) Int. Cl. G09B 7/00; G09B 7/02; G09B 7/06; G09B 5/02

(52) U.S. Cl. CPC G09B 7/00; G09B 5/02; G09B 7/02; G09B 7/06

(57) ABSTRACT

The disclosed technology, in certain embodiments, generates customized assessments based on educational content to match the needs and learning styles of individual learners. The educational content may be identified and provided to a user based on user profile information such as grade, age, and/or education level. Moreover, the disclosed technology can adapt the educational content for an individual user based on a preferred learning style of the user.

### RELATED APPLICATIONS

This application claims priority from U.S. Patent Application No. 61/670,296, entitled “Software System with Personalisation, Assessment, and Curation Capability,” filed Jul. 11, 2012, herein incorporated by reference in its entirety.

### FIELD OF INVENTION

This invention relates generally to systems and methods for providing personalized educational content to users. More particularly, in certain embodiments, this invention relates to systems and methods for providing personalized educational content to users based on their learning preference, ability, and/or predisposition.

### BACKGROUND

Individuals often process information differently. Every learner displays different preferences for learning and different outcomes based on learning experiences. Most individuals exhibit certain preferences or predispositions for several parameters within a learning ecosystem. Different individuals prefer to learn at different times, different speeds, and different content or different modalities. Some learners may display one of several basic learning styles, e.g., visual, auditory, or kinesthetic learning. Some users may like to learn math in the morning using text based material, but social studies in the evening with pictographic or video based material.

Many education systems provide content to teachers for use in courses or lesson plans or directly to students in a standard format and/or style. They generally do not take into consideration the learners' preferences for various parameters, which can vastly affect the educational experience and learning progress of the students. Most systems do not assist teachers in either selecting content or analyzing classes or learners from different signs or signals. Such systems do not take into account the learners' preferred time of day to learn specific content, the number of comments the learners make in the system, how often learners interact with other learners through the platform, what type of content learners interact with and how they perform during subsequent assessments. Most systems fail to analyze user interactions with an education system to determine if the learners are involved in the learning or if they are just going through the motions without increasing their mastery of the subject matter. Traditional education systems provide content to a large population irrespective of a learner's individual learning preference, ability, or predisposition. Additionally, student research is often conducted without regard to a learner's individual learning preference, strengths or frequency of interaction. Thus, there is a need for systems and methods for providing educational content and analysis to users based on their personality, learning preference, ability, and/or predisposition.

### SUMMARY

The disclosed technology, in certain embodiments, provides a personalized educational platform that can be customized to meet the preferences, abilities, and/or predispositions of each of its users. The educational platform, in certain embodiments, identifies and provides educational content to a learner based on the needs and preferences of the learner. The educational content may be identified and provided to a user based on user profile information such as grade, age, and/or education level. Moreover, the educational content may be identified and provided to the user based on the preferred learning style of a learner. Providing content to a user based on their learning preference may help increase the individual's retention of the material. It may also help interest a student in new material. Moreover, tailoring educational content according to a student's learning preference may prevent the student from becoming frustrated when he struggles to grasp complex material or attain certain goals.

The disclosed technology, in certain embodiments, generates customized assessments and reports based on educational content to match the needs and learning patterns of individual learners. In certain embodiments, the educational platform monitors the performance and progress of a learner and provides progress reports to teachers and/or parents. The educational platform may monitor the progress of the learner's performance and accordingly recommends content and provides assessments to increase the learner's comprehension and mastery of various topics.

In one aspect, the present disclosure describes a method for providing educational content to a computing device associated with a user that may include receiving a request to provide to a computing device associated with a user educational content associated with a topic. The request may be a selected from a group consisting of: a search request from the computing device associated with a user, a request from a computing device of a parent of the user to provide educational content associated with a topic to the computing device associated with the user, and a request from a computing device of a teacher of the user to provide educational content associated with a topic to the computing device associated with the user. The method may include identifying at least one of a user profile information associated with the user and learning preference information associated with the user, where the learning preference information is based at least in part on information collected from a survey completed by the user. The method may include identifying educational content responsive to the request from a plurality of content sources, where the educational content is identified based on at least one of the identified user profile information and the identified learning preference information. The method may include providing the identified educational content for display on the computing device associated with the user.

In some implementations, the method may include receiving a rating for the educational content provided to the computing device associated with the user from the computing device associated with the user. The received rating may be stored in a memory of the computing device.

In some implementations, the user profile information may include at least one member selected from a group consisting of: user age, user grade level, user location, user profile data of similar users, time of day the user accesses the educational content, social interactions of the user, user assessment scores, peer to peer interactions, historic educational performance of the user, user interests, user preferred language, demographic information.

In some implementations, the method may include identifying a user profile of a second user by comparing the user profile information and learning preference information of the user and the second user, where identifying the educational content is further based at least in part on a content rating provided by a computing device associated with the second user and the user profile of the second user.

In some implementations, the identified educational content may be identified based at least in part on a degree of relation between the educational content and content identified by a computing device associated with a teacher of the user.

In some implementations, the method may include providing an assessment for display on the computing device associated with the user, where the assessment may be automatically generated by the processor of the computing device based at least in part on the text of the educational content.

In some implementations, the method may include identifying an interactive assessment format based at least in part on user profile information from a user profile associated with a user and learning preference information associated with the user. The method may include generating an assessment in the identified interactive assessment format. The method may include providing the assessment in the identified interactive assessment format for display on a computing device associated with a user.

In some implementations, the educational content may be identified further based at least in part on content identified by the teacher of the user.

In another aspect, the present disclosure describes a system including a processor and a memory having instructions that cause the processor to receive a request to provide educational content associated with a topic to a computing device associated with a user to a computing device associated with a user, where the request may be a search request from the computing device associated with a user. The instructions may cause the processor to receive a request from a computing device of a parent of the user to provide educational content associated with a topic to the computing device associated with the user or a request from a computing device of a teacher of the user to provide educational content associated with a topic to the computing device associated with the user. The instructions may cause the processor to identify at least one of a user profile information associated with the user and learning preference information associated with the user, where the learning preference information may be based at least in part on information collected from a survey completed by the user. The instructions may cause the processor to identify educational content responsive to the request from a plurality of content sources, where the educational content may be identified based on at least one of the identified user profiled information and the identified learning preference information. The instructions may cause the processor to provide the identified educational content for display on the computing device associated with the user.

In another aspect, the present disclosure describes a method for conducting an educational assessment that may include retrieving educational content from a content database. The method may include identifying an interactive assessment format based at least in part on user profile information from a user profile associated with a user and learning preference information associated with the user, where the learning preference information is based at least in part on information collected from a survey completed by the user. The method may include generating an assessment in the identified interactive assessment format. The method may include providing the assessment for display on a computing device associated with the user.

In some implementations, the method may include receiving one or more responses associated with the assessment and confidence data for the one or more responses from the computing device associated with the user. The method may include determining a report based on the one or more responses and the confidence data. The method may include providing the report to at least one of a computing device associated with a parent of the user and a computing device associated with a teacher of the user.

In some implementations, the report may include an assessment report and a confidence report, where the assessment report is based at least in part on the one or more responses and the confidence report is based at least in part on the confidence data.

In some implementations, the report may identify at least one of areas of improvement by the user and areas in need of improvement by the user.

In some implementations, the assessment may selected from a true/false quiz, a crossword puzzle, a game, a fill-in-the-blank quiz, and an open ended text quiz.

In another aspect, the present disclosure describes a system including a processor and a memory having instructions that cause the processor to retrieve educational content from a content database. The instructions may cause the processor to identify an interactive assessment format based at least in part on user profile information from a user profile associated with a user and learning preference information associated with the user, where the learning preference information is based at least in part on information collected from a survey completed by the user. The instructions may cause the processor to generate an assessment in the identified interactive assessment format. The instructions may cause the processor to provide the assessment for display on a computing device associated with a user.

In another aspect, the present disclosure describes a method for recommending customized educational content that may include identifying a plurality of user profiles, where each of the user profiles is associated with a learner using an educational platform. The method may include generating a combined class profile based on the plurality of user profiles. The method may include providing a recommendation for educational content to a teacher based at least in part on the combined class profile and a lesson topic, where the lesson topic is identified by the processor from a curriculum standard.

In some implementations, the method may include automatically generating an assessment by analyzing the recommended educational content. The method may include providing the assessment and the recommended educational content to a computing device associated with a learner using the educational platform. The method may include determining an assessment outcome, where the assessment outcome is based on the learner's performance on the assessment. The method may include determining an efficacy score for the recommended educational content based on the assessment outcome. The method may include storing the efficacy score, where at least one of the efficacy score, assessment outcome, and one or more user profiles are used to identify future recommendations for educational content to a teacher.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a system level diagram of an example system for providing a personalized educational platform;

FIG. 2A is a flow diagram of an exemplary method for providing educational content to a learner;

FIG. 2B is a flow diagram of an exemplary method for searching and providing supplemental content to a learner;

FIG. 3 is a flow diagram of an exemplary method for providing an assessment to a learner and preparing an assessment report based on the performance of the learner with respect to the assessment;

FIG. 4 is a block diagram depicting the overall structure of an exemplary educational platform;

FIG. 5 illustrates an exemplary screenshot of a learner device screen displaying a user profile screen;

FIG. 6 illustrates an exemplary screenshot of a learner device screen displaying a learner registration survey;

FIG. 7 illustrates an exemplary screenshot of a learner device screen displaying a dashboard of the educational platform customized for the learner associated with the learner device;

FIG. 8 illustrates an exemplary screenshot of learner device screen displaying several types of content identified from a search conducted by the learner associated with the learner device screen;

FIG. 9 illustrates an exemplary screenshot of learner device screen displaying search results for content based on an input search string:

FIG. 10 illustrates an exemplary screenshot of learner device screen displaying educational content recommended to a learner that is in accordance with a core curriculum standard;

FIG. 11 illustrates a table that associates educational content items with the difficulty level of each content item;

FIG. 12 illustrates an exemplary screenshot of a learner device screen displaying a registration screen prompting a learner to select an interactivity format for an assessment;

FIG. 13 illustrates a table displaying an assessment generated by the educational platform server:

FIG. 14 illustrates an exemplary screenshot of a learner device screen displaying a timeline of the learning activity for a particular learner;

FIG. 15 shows a block diagram of an exemplary cloud computing environment; and

FIG. 16 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Throughout the description, where apparatus, devices, and systems are described as having, including, or comprising specific components, or where processes and methods are described as having, including, or comprising specific steps, it is contemplated that, additionally, there are apparatus, devices, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

As used herein, the term learning “preference” encompasses, for example, a learning predisposition or learning suitability of a learner.

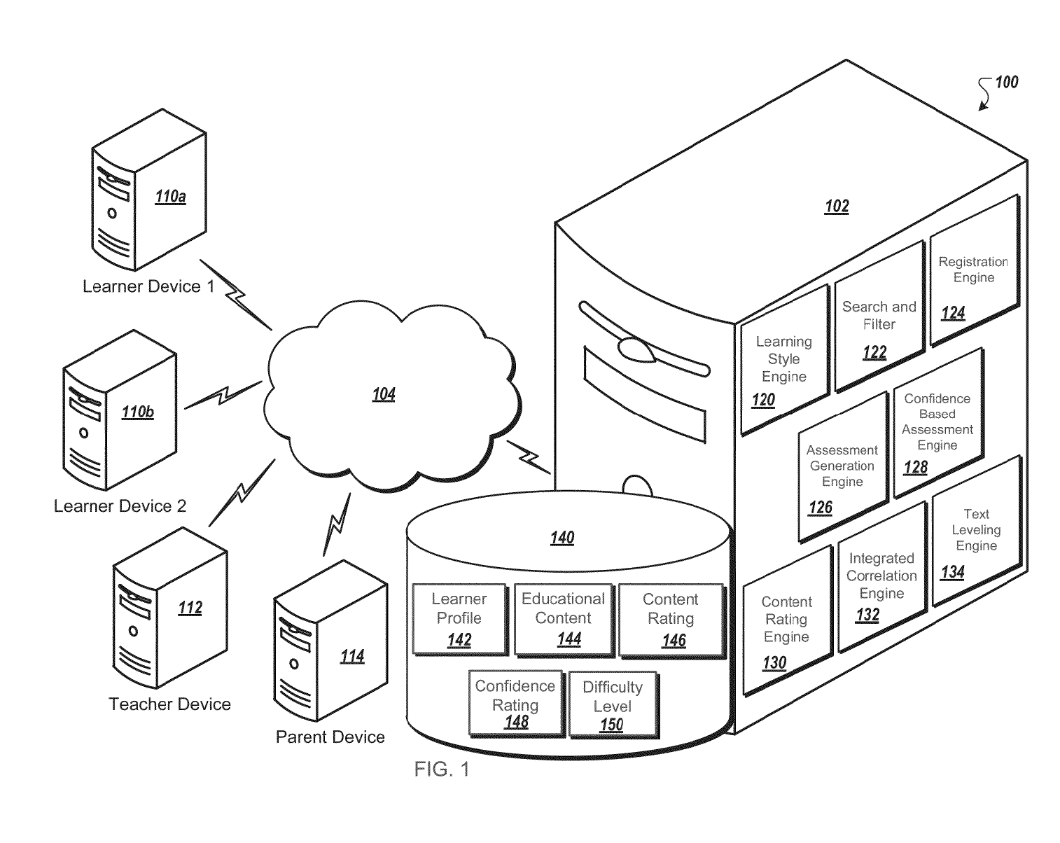

The disclosed technology, in certain embodiments, provides an educational platform that can be customized to meet the preferences of each of its users. The educational platform, in certain embodiments, identifies and provides educational content to a learner based on the profile information of the learner and the learning preferences of the learner. FIG. 1 is a system level diagram of an example system 100 for providing a personalized educational platform is presented. System 100 includes multiple learner devices 110. Although the implementation pictured in FIG. 1 shows two learner devices 110a and 110b, any number of learner devices may be included in system 100 in other implementations. Learner device 110 may be any computing devices that include a display screen and have peripheral input devices (e.g., personal computers, laptops, tablet computers, smartphones, personal media players etc.) that is accessible to a learner (e.g., a student using the personalized educational platform). The learner devices 110 are configured to electronically communicate with an analysis server 102 over network 104. Network may be a wireless network (e.g., WiFi, wireless local area network (WLAN), Internet, cellular telephone network, wireless mesh networks, BlueTooth, etc.). In some implementations, network 104 is a wired network (e.g., Ethernet, local area network, etc.). An educational platform interface, that is generated in part by server 102, is displayed on the display screens of learner devices 110. Teacher device 112 allows a teacher to provide learners, via learner devices 110, with content, assessments, and other materials via the educational platform and monitor the performance of the learners. Parent device 114 allows a parent to provide one or more learners, via learner devices 110, with content and other materials via the educational platform and monitor the performance of the learners. Parent device 114 may also be configured to communicate with teacher device 112 over network 104 to receive recommendations and messages regarding the performance of the learners.

Although illustrated as communicating within the single network 104, in some implementations, communications from learner devices 110, teacher device 112, and parent device 114 may be issued to and from the analysis server 102 over a variety of networks.

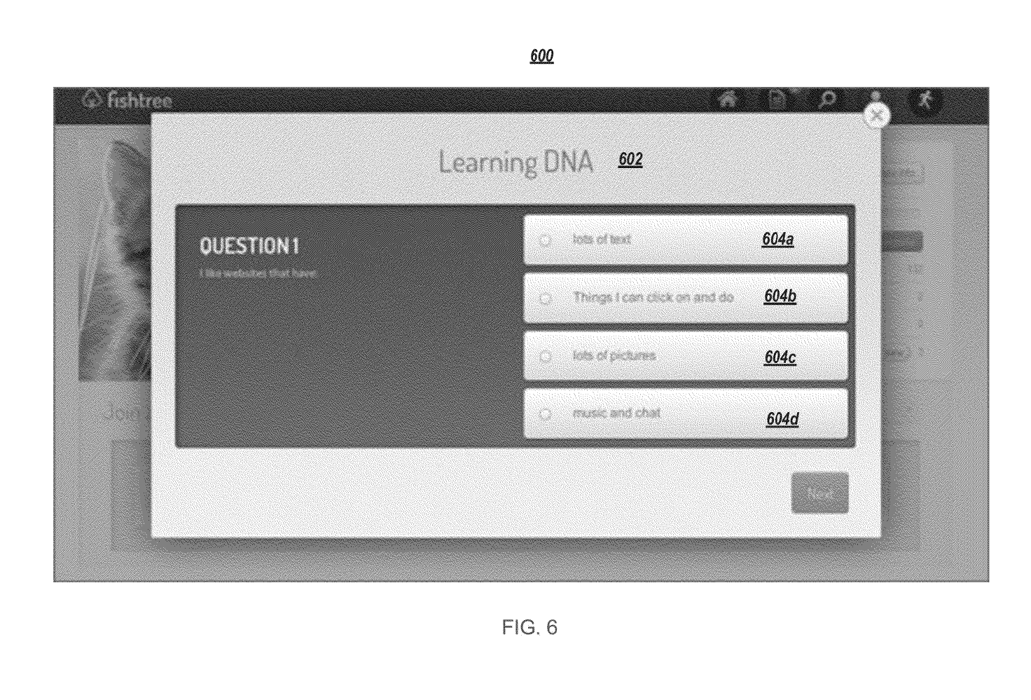

In some implementations, education platform server 102 identifies the learning style that is most effective for a particular learner. For example, learning style engine 120 may employ a series of algorithms to monitor a learner's progress and discover the types of learning tools and formats that are most effective for a particular learner. The learning style engine 120 may be able to determine whether the learner prefers and responds well to content in the mode of a video, audio, text, game or a combination of any of these modes. Learning style engine 120 may present a survey or a questionnaire to a learner, via learner device 110a, to identify the learning style that the learner associated with learning device 110a prefers. Such a questionnaire will be described in detail below in the description associated with FIG. 6. Learning Style engine 120 may assign a learning style score to each learner by monitoring each leaner's performance and ratings for particular modes of educational content. Server 102 may search for additional educational content, provide recommendations on what types of related content to access, or provide the learner with assessments based on the learning style identified to be the most effective for each learner, which may be quantized by the learning style score. Learning score may be stored in database 140 as part of learner profile data 142 for a particular user. The learning style score may be updated over time as the learner interacts with more content and assessments on the educational platform. When any content is assigned to a learner device 110 by teacher device 112 and/or parent device 114, the assigned content may be matched with supplemental content matching both the context, interests, and learning style of the learner and displayed on the display screen of the learning device 110 as a recommendation. By monitoring the performance of a learner, learning style engine 120 may instruct search and filter engine 122 to retrieve educational content that would most benefit the learner and efficiently increase the learner's mastery of the subject matter. By monitoring the performance of a learner, learning style engine 120 may instruct assessment generation engine to adjust the difficulty level of the assessments to increase the learner's mastery of the subject matter.

In some implementations, educational platform server 102 monitors the interactions and performance of a learner in order to recommend personalized content. For instance, learning style engine 120 may monitor the time of day that a learner uses the educational platform and the duration of each learner session with the educational platform. In addition, learning style engine 120 may monitor and log the nature of the learner interaction with the educational content, assessments, and other features of the educational platform. For instance, learning style engine 120 may monitor the amount of time a learner spends on particular pages and the learner's click through rate on various assessments and items of educational content to identify the learner's interests and mastery of the content. Learning style engine 120 may also monitor a learner's social interactions associated with educational content items. For instance, learning style engine 120 may monitor the frequency and nature of the learner's content ratings (thumbs-up rating, star ratings, etc.), social media tags, learner comments for educational content items to determine the amount of interest a particular learner has for a particular item or types of educational content. Learning style engine 120 may also monitor the communications exchanged between a learner and other learners, parents, and teachers on the educational platform to assess the quality of learner performance, learner interest in certain subjects, and other characteristics of the learner. By monitoring these interactions of users within the educational platform, educational platform server 102 may recommend educational content that is personalized to a learner and would be targeted to best help the learner master the content.

In some implementations, learning style engine 120 allows teachers to directly assess the learning styles of their learners. For example, learning style engine 120 may be configured to allow teachers to include one or more questions in an assessment or learner registration survey via teacher device 112. In some implementations, learning style engine 120 generates one or more learning style questions based on the content that a teacher assigns a student via teacher device 112.

In some implementations, education platform server 102 collects initial information for each learner to build a learner profile through a learner registration process. For example, registration engine 124 collects learner data which it uses to build a learner profile 142. Registration engine 124 may provide the user with a survey or questionnaire as described below in connection with FIG. 6. The survey may collect information such as demographic information, age, gender, grade, learner interests, preferred language, and which other learners the learner is friends with, nationality, and user location. In some implementations, registration engine 124 may collect such information through an interactive game. The game may be designed such that the learner inputs to the game and/or the manner in which the learner plays the game allow registration engine 124 to collect learner profile information. Once registration engine 124 collects such information through the registration process, such information may be stored in database 140 as learner profile data 142. Registration engine 124 may periodically update the learner profile information in order to fine tune the personalization of the education platform as the learner's learning preferences and abilities change over time. In some implementations, registration engine 124 is configured to identify a personality type of the learner by means of prompts in a registration survey. For example, the registration engine 124 may be configured to construct a Myers Briggs profile for each learner. Based on the constructed personality profile, server 102 may be configured to retrieve content and assessments that will be the most effective in educating the learner.

In some implementations, education platform server 102 identifies content that is best suited for the learner. Search and filter engine 122 may be configured to search and index content from various content databases, located remotely or in database 140, to best identify content that suits the learners' needs. Search and filter engine 122 may trawl remote databases through the Internet and several locations identified by server 102 to return content that is in accordance with each learner's profile and search queries.

In some implementations, search and filter engine 122 identifies content based on a search string input by learners, via learner devices 110. Search and filter engine 122 receives a search string input by a learner into learner device 110. Search and filter engine 122 correlates the input search string with learner profile data 142 for the learner associated with the learner device 110 that it has received the input search string from. Search and profile engine 122 may correlate the input search string with user profile data for each learner such as age, demographic information, preferred language and grade level of the learner. Furthermore, search and profile engine 122 may be configured to identify individual learning history information that the learning style engine 120 has identified such as past educational performance and interests of the learner, and personal learning profile data of other learners that the learner has designated as his contacts or friends on the educational platform. Search and filter engine 122 may be configured to identify educational content from the various content databases based upon any one of or a combination of the learner profile data, learner device input search string, learning style preferences, user interaction data collected by learning style engine 120, and user profile data of the learner and his friends. Based on a combination of these parameters, the search and profile engine 122 identifies and educational content that is best suited for a learner and recommends such identified content to the learner via learner device 110.

In some implementations, server 102 provides educational content recommendations to a teacher device 112 to be included as core curriculum to be distributed to multiple learners. For example, search and filter engine 122 may recommend content to a teacher device 112 by determining the user profile preferences, learning styles, and learner interactions of multiple learners enrolled in a class that the teacher associated with teacher 112. For example, search and filter engine 122 may identify educational content that best meets the interests, preferences, and learning styles of most of the learners in a classroom as core curriculum content. Upon identifying such educational content, search and filter engine 122 may provide such content recommendations to a teacher, via teacher device 112, to include in the core curriculum. Server 102 may provide educational content items included in the core curriculum to all learners, via their respective learner device 110. Server 102 may provide educational content that matches the preferences of most of the learners enrolled in a class.

In some implementations, server 102 is configured to provide core content curriculum to a learner device 110 that has been assigned to the learner by a teacher or a parent. For instance, search and filter engine 122 may receive a command to provide a particular content to a learner, by means of a learner device 110, from a teacher device 112 or a parent device 114. Such a received command may identify the content that the parent or teacher desires to be provided to the learner. Search and filter engine 122 may retrieve the identified content from an educational database and present the identified content to a learner device 110.

In some implementations, server 102 is configured to recommend educational content to supplement the core curriculum provided to a learner. For example, search and filter engine 122 may be configured to search content databases, via the Internet to find supplemental content related to the core curriculum content. Search and filter engine 122 may be configured to search content databases for content that matches the preferences of a particular learner associated with a learner device 110. Search and filter engine 122 may determine the learning preferences of a particular learner device. As an example, search and filter engine 122 may identify that the learner associated with learner device 110a prefers to receive educational content in the form of videos. In this example, learner device 110a receives core curriculum educational content from a teacher, a text article about the solar system, via teacher device 112. Search and filter engine 122 identifies that the learner associated with learner device 110a prefers to receive content in a video format, by analyzing learner profile data 142, and searches content databases online to find an educational video about the solar system. Search and filter engine 122 may be configured to rank supplemental educational content based on the number of parameters of a learner profile that each item of educational content matches. Search and filter engine 122 may recommend a limited amount of supplemental content to a learner device 110, by order of highest to lowest ranking.

In some implementations, search and filter engine 122 bases its educational content recommendations to learner devices 110 and teacher device 112 based on any combination of received signals from learning style engine 120, registration engine 124, content rating engine 130, and confidence based assessment engine 128. For example, search and filter engine may recommend educational content customized to a learner or a classroom of users based on one or any combination of peer to peer interaction signals, signals indicating similar learner profiles in educational platform system 100, signals indicating the time of day the learner is most active, signals indicating the social interactions (user comments for content items, social media updates, user communications, content ratings), signals indicating the assessment scores and confidence levels of learners, signals indicating the time a learner spent on a particular content item or an assessment, and signals indicating learners' behaviors such as click through rate, and signals indicating user profile data of learners such as gender, age, grade level, language, location, interests, and learning styles. Once a core curriculum content has been assigned to learners enrolled in a classroom, server 102 may be configured to recommend personalized educational content based on any combination of the above signals.

In some implementations, server 102 stores associations between core curriculum content provided to a learner device 110 and one or more items of supplemental content that search and filter engine 122 identifies as being related to the core curriculum content. For example, integrated correlation engine 132 associates supplemental online content to core curriculum content. Integrated correlation engine 132 may be configured to link an item of core curriculum content to an item of supplemental content. Integrated correlation engine 132 may be configured to associate content generated by a user of system 100 (i.e, a teacher using teacher device 112 or a parent using parent device 114 or another learner using one of learner devices 110) with an item of core curriculum content. In an implementation, such a user of system 100 may indicate which item of core curriculum content the user generated content should be linked to. In another implementation, search and filter engine 122 may identify which item of core curriculum content such user generated content should be linked to. Integrated correlation engine 132 may receive such associations between the core curriculum content and supplemental content from a user of system 100 or search and filter engine 122. Once integrated correlation engine 132 receives such content association information, integrated correlation engine 132 may compile a table of associations that lists each item of supplemental content associated with each item of core curriculum content.

In another implementation, integrated correlation engine 132 associates supplemental educational content with a core curriculum standard. For example, an educational organization may set forth a standard consisting of certain rules and parameters that governs the types of educational content that is delivered to learners. Such a standard sets rules and restrictions are generated to select educational content for a core curriculum. Integrated correlation engine 132 may be configured to identify the educational standards of all educational institutions and organizations that a learner associated with a learner device 110 is a member of. Upon identification of such a core curriculum standard, integrated correlation engine 132 may be configured to instruct search and filter engine 122 to identify appropriate educational content that meets the criteria established by the core curriculum standard. Once such material conforming to the requirements of the core curriculum standard is found, integrated correlation engine 132 may integrate such content into an overall lesson plan for the learner. Upon finding content educational content that conforms to a core curriculum standard, integrated correlation engine 132 may identify which core curriculum standard, the identified content should be associated with. In addition, integrated correlation engine 132 may recommend additional content that aligns with the identified core curriculum standard.

In some implementations, education platform server 102 assigns ratings to each item of educational content associated with the education platform. For example, content rating engine 130 may be configured to automatically rate content based on how effective the content was in educating a learner or receive ratings manually assigned by a learner, via learner device 110, to an item of educational content. As an example, learners may assign a rating to each item of educational content by assigning a certain amount of stars out of a maximum amount of stars. Upon receiving such a rating from the user, content rating engine 130 may assign the rating to an educational item and store the rating in database 140 as content rating 146. In some implementations, content rating engine 130 may automatically assign a rating to an item of educational content based on the efficacy of the content. For example, content rating engine 130 may examine a learner's score on an assessment associated, either directly or indirectly, with a particular item of educational content and from that score, determine how effective a particular item of educational content was in teaching the learner. Based on the score of one or more assessments associated with the content, content rating engine 130 may be configured to assign each item of educational content with a rating and store the rating as content rating 146 in database 140.

In some implementations, content rating engine 130 may affect how an item of educational content is displayed in search results. For example, content rating engine 130 may cause an item that was ranked poorly to rank very low or be removed from search results generated by search and filter engine 122. Content rating engine 130 may affect how often an educational content is recommended based on its rating. For instance, an item that has been ranked highly will show up in search results generated by search and filter engine 122 and will be recommended by educational platform server 102. However, an item that has been ranked poorly may not show up in search results generated by search and filter engine 122 and thereby may not be recommended by educational platform server 102.

In some implementations, content rating engine 130 reports the efficacy of items of educational content, as determined by the content rating 146 assigned to the content, to a teacher device 112 or a parent device 114. This allows the teacher or parent to monitor student progress and learn which types of content and subject areas a learner is performing well or poorly in.

In some implementations, educational platform server 102 parses the content of any educational content item that it provides to a learner device 110. Text leveling engine 134 uses natural language processing algorithms to parse the text of the education content item. Upon parsing the text, text leveling engine 134 examines the text's structure and determines its difficulty level by analyzing characteristics of the text such as syllable patterns, word difficulty, sentence length, frequency of difficult words, etc. Upon analyzing the text for difficulty level, text leveling engine 134 converts the determined difficulty level into an approximate grade level. As an extra level of refinement within the identified grade level, text leveling engine 134 may also assign a particular content item's text with a difficulty level. For instance, a text may assigned a difficulty level of medium difficulty for a fourth grade level. Such a ranking allows the education platform server 102 to provide a learner more challenging content within the learner's grade level once the learner is progressing well with educational material of easier difficulty. Text leveling engine 134 may assign the calculated difficulty level to the educational content and may store this association in database 140 as difficulty level data 150. Once difficulty level data 150 is stored in database 140, educational platform server 102 may recommend content to learners of learner devices 110 by determining the level of difficulty of content that the learner is prepared for and providing the user with a recommendation for content with that appropriate difficulty level rating.

In some implementations, educational platform server 102 generates assessments based on an item of educational content. For example, assessment generation engine 126 may be configured to automatically generate an assessment in accordance with data from a learner profile and the content of an educational content item. Assessment generation engine 126 may apply natural language processing algorithms to parse the content of an educational content item and generate questions based on the content. Assessment generation engine 126 may be configured to generate an assessment in a format that the learner prefers by determining the learner's assessment format preference stored in the learner profile in database 140. For instance, a learner may prefer multiple choice questions based assessments. Assessment generation engine 126 may generate multiple choice tests for a piece of educational content upon determining a learner's preference for multiple choice based tests.

In some implementations, assessment generation engine 126 generates assessments based on a difficulty level. For instance, assessment generation 126 may generate questions considering the difficulty level of the question. Natural language processing algorithms or the content itself may identify a difficulty level of the content. The difficulty level of the content itself may factor into determining the difficulty level of an assessment questions. Assessment generation engine 126 may be further enabled to generate questions of various levels of difficulty for a particular item of educational content using a variety of natural language algorithms and test generation software. Assessment generation engine 126 may receive information from learning style engine 120 that instructs the assessment generation engine 126 the level of difficulty that the assessment needs to possess.

In some implementations, assessment generation engine 126 generates answers to assessment questions. Such answers are often found in the educational content from which the assessment question was generated. Assessment generation engine 126 may also obtain answers by searching educational databases online or other references stored locally that are accessible to education platform server 102. In certain implementations, assessment generation engine 126 may fact check a question it has generated against other references related to the subject matter of the generated question to determine that the question is a valid question.

In some implementations, assessment generation engine 126 generates assessment questions from a textual content using method of missing word identification. For example, assessment generation engine 126 may generate Cloze tests using an algorithm that removes words from a statement based on certain characteristics such as word difficulty (based on the number of characters or syllables), sequence of words, and specific words related to a learning object. Such Cloze tests employ the benefits of a spaced-practice effect that relies on repetition of topics over closely spaced periods of time. Assessment generation engine 126 may normalize an assessment question or an entire assessment to a particular grade level to suit the difficulty level of a learner. Assessment generation engine 126 may remove words from a text passage from the educational content to generate an assessment using the Cloze method and allow a learner to fill in the missing word using an interactivity format that the learner profile indicates that the learner prefers (i.e., fill in the blank, drag and drop, crossword puzzle, word-maze, word invader game, etc.). Assessment generation engine 126 may also be configured to generate incorrect answer choices to present to the user to pick from. Assessment generation engine 126 may generate these incorrect answer choices by using other removed words from the text of the educational content, synonyms, antonyms, or random dictionary words. Once the learner fills in the missing words, using learner device 110, through any of the interactivity formats in which the assessment has been generated, assessment generation engine 126 checks the learner entered response against the answer that assessment generation engine 126 has determined to score the assessment. Assessment generation engine 126 may be configured to score the entire assessment and create an assessment report. Server 102 may provide teacher device 112 and parent device 114 with the generated assessment report. Such an assessment report may include a detailed breakdown of the strengths and weaknesses of each learner with respect to the subject matter of the assessment. Such an assessment report may take into account past assessment reports to indicate a learner's progress over time.

In some implementations, assessment generation engine 126 generates assessments using natural language processing algorithms. Assessment generation engine 126 may be configured to extract meaningful information from items of educational content and may be configured to produce natural language output in the form of assessment or any other form of communication with a learner device 110, teacher device 112, and parent device 114. Assessment generation engine 126 employs natural language processing algorithms to gather information on the topic of an educational content item by determining answers to the Five W and one H questions—who, what, where, when, why, and how. Upon determining answers to these questions, assessment generation engine 126 may be configured to correctly understand the text and generate assessment questions and correct answers to those generated questions to use in an assessment presented to a learning device 110 associated with a learner. In some implementations, text leveling engine 134 may generate questions and create correct answers using natural language processing algorithms and Cloze tests.

In some implementations, educational platform server 102 collects feedback from a learner, via a learner device 110, on how confident the learner is in answering an assessment question. Confidence based assessment engine 128 may prompt a learner, through the assessment generated by assessment generation engine 126, how confident the learner is in answering that particular question. The information provided by the learner regarding their confidence may be used to determine a confidence rating 148. The confidence rating may be an rating representative of the user's confidence in a particular subject area. Confidence based assessment engine 128 may analyze the learner's response to create a confidence report. Server 102 may provide teacher device 112 and parent device 114 with such a confidence report which, combined with the assessment report, provides a complete overview of the learner's strengths and weaknesses for an assessment or subject matter and the learner's perceived strengths and weaknesses. Confidence based assessment engine 128 may also include, in the confidence report, tips to parents and teachers, on how to better focus on areas that the learner feels unconfident in and tips on how to encourage the learner to perform well in the areas of low confidence. Confidence based assessment engine 128 may also analyze the confidence report with the assessment report, and past performance of the learner to identify progress of the learner in a subject area. Confidence based assessment engine 128 may provide the learner device 110, parent device 114 and teacher device 112 with information on the learner's progress.

In some implementations, confidence based assessment engine 128 attempts to determine whether a learner is completely guessing or not by matching the assessment response of the learner with the confidence response of the user for an assessment prompt. For example, confidence based assessment engine 128 may flag an assessment question or subject area in which it determines that the learner has answered a question randomly and answered the confidence level prompt randomly. Confidence based assessment engine 128 may be configured to determine such random guesses from intelligent guesses by analyzing the learner's past history in answering such assessment prompts.

At the end of the assessment, server 102 provides a learner, via learner device 110, an assessment summary chart showing color-coded marks (red, green and yellow) for each question based on their answer and their level of certainty. Learners obtain these color-coded cues to alert them of the accuracy of their knowledge and certainty. There is no penalty or reward for having high, medium or low certainty in an answer, but confidence based assessment engine 128 may provide the learner (and their supervisor) with a clearer understanding of his or her depth of knowledge. The confidence based assessment engine 128 encourages learners to analyze all issues related to a question, not just the question alone and gain confidence by contemplating and identifying the reliability of their answers. The confidence based assessment engine 128 may also encourage the learners to analyze how much and how well they understand new concepts and help them identify misconceptions about their knowledge, allowing them to reflect on the concepts and better understand their misconceptions. In some implementation, server 102 may provide tips and lessons to instructs and students on how to properly answer the confidence based assessment questions in order to properly create confidence reports to help the learners learn the content effectively.

In some implementations, educational platform server 102 matches learners taking the same test with one another. For example, once server 102 determines that learners using learner device 110a and learner device 110b have both taken the same assessment, server 102 may notify both learners that they have both taken the same assessment and provide both learner devices with the opportunity to communicate with one another. For instance, server 102 may allow the learners of learner devices 110a and 110b with an instant message or other form of communication through the educational platform about the lesson and assessment that they have both completed. Server 102 may provide both learners with the opportunity to retake the assessment upon detecting that the learners have communicated with one another. Assessment generation engine 126 may be configured to track whether either learner's performance has improved as a result of the communication.

In some implementations, educational platform server 102 allows a learner to provide a brief synopsis of the lesson through learner device 110. For example, server 102 may provide learner devices 110 with software that allows the learner to post a social networking notification such as a Facebook status update or a Twitter update with a synopsis of the lesson or a comment about the assessment that the learner has just completed. Server 102 may associate such a social networking notification with the lesson or assessment that the learner has completed and store such notifications in database 140. Educational platform server 102 may be configured to text mine such notifications to create a concise version of a curriculum, or recommend lessons and assessments to other learners. Educational platform server 102 may allow parent device 114, teacher device 112, and even other learner devices 110 to edit such notifications.

In some implementations, educational platform server 102 stores educational content, assessments, and lesson plans on a virtual pinboard that is visible to all users of the educational platform. Educational platform server 102 may allow a user to post content that they have identified from online databases on such a virtual pinboard for later use by other users of the system. Educational platform server 102 may display a pin icon next to such identified content. Educational platform server 102 may allow each user to customize their own virtual pinboard which consists of an individual user's lesson plan, core curriculum and supplemental content, assessments, assessment reports, and confidence reports. Educational platform server 102 may allow a user to share their own virtual pinboards with other users of the educational platform. An anonymous user who has not logged into the educational platform will store their activity on temporary pinboard that may be destroyed, upon completion of their session, if the anonymous user does not wish to log in to the educational pinboard to store their temporary session and pinboard activity.

In some implementations, a teacher logs into the educational platform, using teacher device 122, to create a lesson plan. Server 102 recommends educational content to the teacher based on the topic or curriculum standard and the grade level he is teaching. Server 102 may automatically recommend the standard if server 102 semantically matches keywords of the topic the teacher starts to type using teacher device 122. The teacher may be allowed to override the curriculum standard suggested by server 102, using teacher device 112, adding an additional layer of quality assurance. Server 102 may be aware of which class the teacher intends to use the lesson plan for, and accordingly server 102 uses the combined class profile to suggest the most appropriate instructional content at the class level. The teacher, using teacher device 112, may be further allowed to add an assessment to the instructional content selected by the teacher. The assessment added by teacher device 122 may be automatically generated from text-based material if chosen by the teacher. Additionally, some assessment questions may added manually by the teacher. Once the lesson plan is finalized, the teacher may teach the lesson to the class either in person or by recording one or more videos that will distributed to learners, via learner devices 110, enrolled in the teacher's class. Once the lesson is completed, the teacher assigns, via teacher device 112, the activities within the lesson plan to all learners enrolled in the class with a deadline and some instructional notes. Once a learner logs into the educational platform, via learner device 110, the learner is notified that a new activity is pending, and learner is allowed to begin the activity. Server 102 may present the learner with the instructional notes and content that the teacher has assigned. The educational platform server 102 may further recommend supplemental content associated with the core curriculum content provided by the teacher to the learner based on their own learning styles, user profile, and interests. The educational platform server 102 may monitor which content the learner accesses and how much time he spends on that content. Server 102 may log the scores of an assessment that the learner takes and assigns an efficacy score to the content that was accessed based on the outcome of assessment. All of this together may be used to continually and/or dynamically adjust the recommendation weighting of content not only for individual learners but for also for learners with similar profiles.

Although education platform server 102 has been described above and in FIG. 1 as a single server, the tasks performed by server 102 may be performed by a central processing system that may include a number of interrelated computing devices (e.g., servers, systems, storage facilities, etc.) working in coordination to perform the features described above in relation to the various modules.

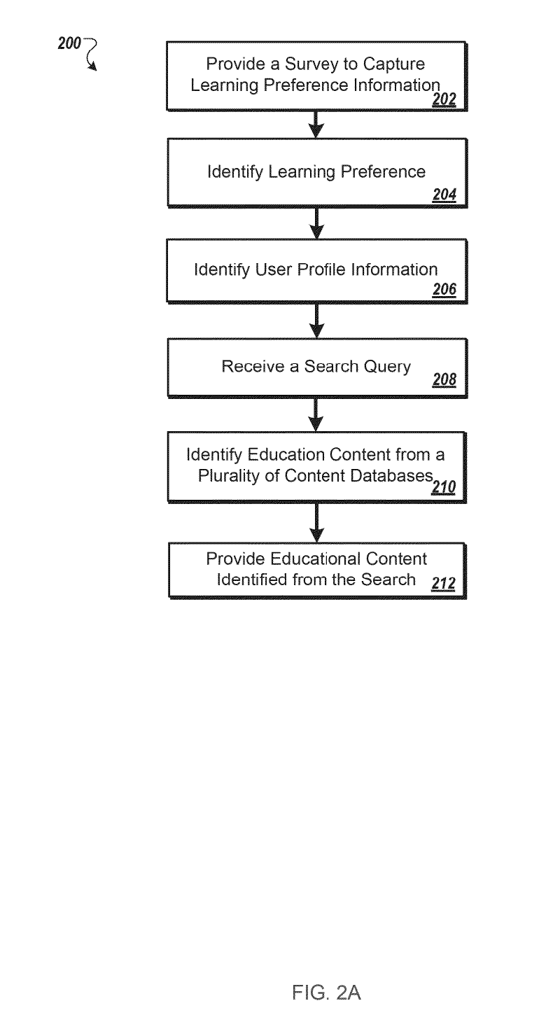

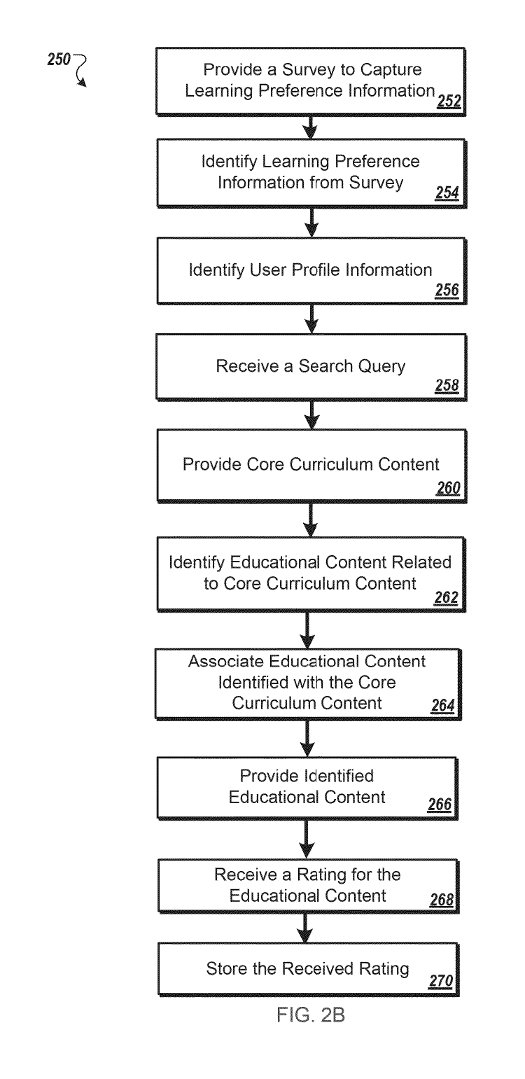

FIGS. 2A and 2B illustrate flow diagrams of exemplary methods 200 and 250 for providing education content to a learner. Methods 200 and 250, in some implementations, are performed by a server such as the educational platform server 102 described in relation to FIG. 1. In some embodiments, methods 200 and 250 are performed by multiple computing devices, such as a combination of the server 102, learner devices 110, teacher device 112, and parent device 114. Methods 200 and 250, in some implementations, are performed by a search and filter engine such as the search and filter engine 122 as described in relation to FIG. 1.

In some embodiments, the method 200 begins with providing a survey to capture learning preference information (202). For example, registration engine 124 of FIG. 1 prompts a learner, through a learner device, to answer survey questions that identify his learning preferences, user profile information, and other demographic information.

In some embodiments, educational platform server 102 identifies the learning preference of a learner (204). For example, the registration engine 124 may identify how often the learner likes to receive new content, how many tests he likes to take per session, how much teacher and parent involvement he prefers, etc. Educational platform server 102 may store such learning preference information in database 140 of FIG. 1 as part of the learner profile data 142.

In some embodiments, educational platform server 102 identifies the user profile information of learner associated with a learner device (206). For example, the registration engine 124 stores the learner input answers to the survey questions as learner profile data 142 in database 140. From such learner profile data, educational platform server 102 is able to identify the user's demographic information, age level, grade level, and even past educational history.

In some embodiments, educational platform server 102 receives a search string from a learner via a learner device (208). For example, the educational platform server 102 may receive a learner input search for a particular subject matter or multiple subject matters. The educational platform server 102 may store such learner input search string temporarily in order to perform a search for educational content using a combination of the search string and learner profile information.

In some embodiments, educational platform server 102 searches a plurality of content databases for content based on identified learning preference information, the learner input search string, and user profile information of the learner (210). For example, the search and filter engine 122 of FIG. 1 may search multiple online databases and content generated by users of the educational platform for content that matches the input search string and complies with the identified learner preferences of the learner. The resulting content may be further filtered based on user profile information such as grade level, past performance history of the user to retrieve content that is target specifically to the needs of each specific learner.

In some embodiments, educational platform server 102 provides the educational content identified from the search (212). For example, once educational platform server 102 has identified one or more items of educational content that match the input search string, user profile information, and the learner's learning preference information, server 102 may provide the learner device 110 associated with the learner with the one or more identified content items from the search. Alternatively, server 102 may provide leaner device 110, which is associated with the learner, with a hyperlink to the content items.

FIG. 2B illustrates a method 250 for searching and providing supplemental content to a learner in addition to providing the learner with core curriculum content.

In some embodiments, the method 250 begins with providing a survey to capture learning preference information (252). For example, registration engine 124 prompts a learner, through a learner device, to answer survey questions that identify his learning preferences, user profile information, and other demographic information.

In some embodiments, educational platform server 102 identifies the learning preference of a learner (254). For example, the registration engine 124 may identify how often the learner likes to receive new content, how many tests he likes to take per session, how much teacher and parent involvement he prefers, etc. Educational platform server 102 may store such learning preference information in database 140 of FIG. 1 as part of the learner profile data 142.

In some embodiments, educational platform server 102 identifies the user profile information of learner associated with a learner device (256). For example, the registration engine 124 stores the learner input answers to the survey questions as learner profile data 142 in database 140. From such learner profile data, educational platform server 102 is able to identify the user's demographic information, age level, grade level, and even past educational history.

In some embodiments, educational platform server 102 receives a search string from a learner via a learner device (258). For example, the educational platform server 102 may receive a learner input search for a particular subject matter or multiple subject matters. The educational platform server 102 may store such learner input search string temporarily in order to perform a search for educational content using a combination of the search string and learner profile information.

In some embodiments, educational platform server 102 provides core curriculum content to the learner device (260). For example, server 102 searches a list of core curriculum topics identified by the teacher device or a core curriculum standard of an educational institution using the learner input search string to provide the learner device associated with the learner with one or more core curriculum content items associated with the search string. Alternatively, server 102 may provide leaner device 110 associated with the learner with a hyperlink to the core curriculum content items.

In some embodiments, educational platform server 102 identifies educational content related to the core curriculum content (262). For example, educational platform server 102 searches a plurality of content databases for supplemental content that is related to the subject matter of the core curriculum content based on identified learning preference information, the learner input search string, and user profile information of the learner. The search and filter engine 122 may search multiple online databases and content generated by users of the educational platform for content that matches the input search string and complies with the identified learner preferences of the learner. The resulting content may be further filtered based on user profile information such as grade level, past performance history of the user to retrieve content that is target specifically to the needs of each specific learner.

In some embodiments, educational platform server 102 associates the educational content identified in step 262 with the core curriculum content (264). For example, integrated correlation engine 132 of FIG. 1 may associate the supplemental content items from the search conducted based on the learning preference information of the learner, the learner input search string, and user profile information of the learner with the core curriculum content identified from the search conducted by the learner based on the input search string. Integrated correlation engine 132 may store such associations in database 140. Additionally, integrated correlation engine 132 may also store the supplemental identified content items as educational content 144 in database 140.

In some embodiments, educational platform server 102 provides the identified educational content to the learner device (266). For example, server 102 provides the learner device associated with the learner with one or more core supplemental educational content items identified from the search. Alternatively, server 102 may provide the learner device with a hyperlink to the supplemental educational content items.

In some embodiments, educational platform server 102 receives a rating for the educational content from the learner device (268). For example, content rating engine 130 of FIG. 1 may receive a rating from a learner device 110 for the supplemental educational content. The content rating engine 130 may store such a rating received from the learner device as content rating 146 in database 140 (270). Server 102 may further use the stored content rating to improve user customization of the searches to match the learner's preferences for supplemental content, as reflected by the content rating. For example, content similar to the supplemental content that the learner rated poorly may not be identified in future searches and content similar to the supplemental content that the learner rated highly may be recommended in future searches.

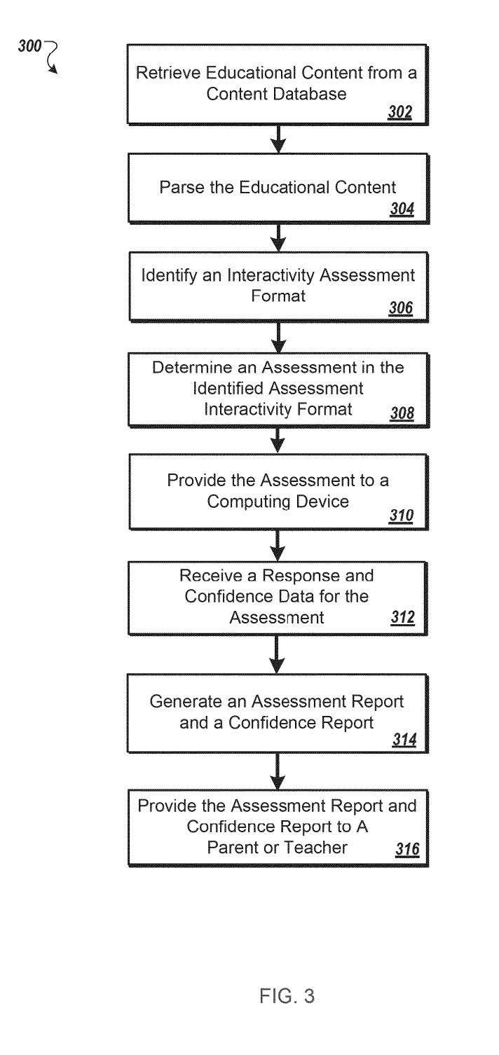

FIG. 3 is a flowchart that illustrates a method 300 for providing an assessment to a learner and preparing an assessment report based on the performance of the learner with respect to the assessment. Method 300, in some implementations, is performed by a server such as the educational platform server 102 described in relation to FIG. 1. In some embodiments, method 300 is performed by multiple computing devices, such as a combination of the server 102, learner devices 110, teacher device 112, and parent device 114. Methods 200 and 250, in some implementations, are performed by assessment generation engine 126 and confidence based assessment engine 128 as described in relation to FIG. 1.

In some embodiments, method 300 begins with retrieving educational content from a content database (302). For example, educational platform server 102 may retrieve educational content from multiple content databases as described in relation to FIG. 2A and FIG. 2B. Server 102 may store such retrieved educational content in content database 140 of FIG. 1.

In some embodiments, educational platform server 102 parses the educational content (304). For example, text leveling engine 134 of FIG. 1 may use natural language processing algorithms to deconstruct sentences in the text of the educational content for assessment generation.

In some embodiments, educational platform server 102 identifies an interactivity assessment format best suited for learners (306). For example, registration engine 124 of FIG. 1 may determine what format of interactivity the learner prefers for an assessment (multiple choice, true or false, fill in the blanks, etc.) as a result of a survey question answered by a learner.

In some embodiments, educational platform server 102 determines, using a machine learning algorithm, an assessment from the parsed content in the identified assessment interactivity format (308). For example, assessment generation engine 126 generates an assessment in the interactivity format identified by the learner using natural language processing algorithms. Assessment generation engine 126 may generate Cloze tests and may also validate its own questions by checking online databases and references materials. Assessment generation engine 126 may also generate the correct answer choice and incorrect answer choices for the assessment. Assessment generation engine 126 may also prompt the learner for how confident the learner is in answering each question of the assessment.

In some embodiments, educational platform server 102 provides the generated assessment to a learner device (310). For example, server 102 may provide the learner device 110 of the learner with the assessment generated by assessment generation engine 126.

In some embodiments, educational platform server 102 receives a response and learner confidence data for each question of the assessment from the learner device (312). For example, server 102 may receive the responses to each assessment question and learner confidence level data for each question. Server 102 may store such learner response data and confidence level data in database 140.

In some embodiments, educational platform server 102 generates a learner assessment report and confidence report (314). For example, server 102 may score the completed assessment by comparing the learner responses to each question against the correct answer choices generated by assessment generation engine 126. Server 102 may generate the learner assessment report summarizing the results of the assessment and the areas of strength and weaknesses of the user. Additionally, server 102 may correlate the learner responses for each question along with the confidence data received from the learner for each question to determine how comfortable the learner feels with certain topics. Server 102 generates the confidence report based on the cumulative results of the confidence level data and the assessment question responses received form the learner for the assessment.

In some embodiments, educational platform server 102 provides the generated learner assessment report and confidence report to the parent device and teacher device (316). For example, server 102 may provide at least one or more teacher device 112 of FIG. 1 and parent device 114 of FIG. 1 with the assessment report and confidence report for each learner. These reports may identify the strengths and weaknesses of each learner and may provide suggestions on which areas to focus on in order for the learner to effectively learn the material.

Although described in relation to a particular series of steps, in some implementations, methods 200, 250, and 300 may include more or fewer steps. In some implementations, one or more of the steps of the methods 200, 250, and 300 may be arranged in a different order. Other modifications of methods 200, 250, and 300 are possible without deviating from the concepts and scope of the methods 200, 250, and 300, respectively.

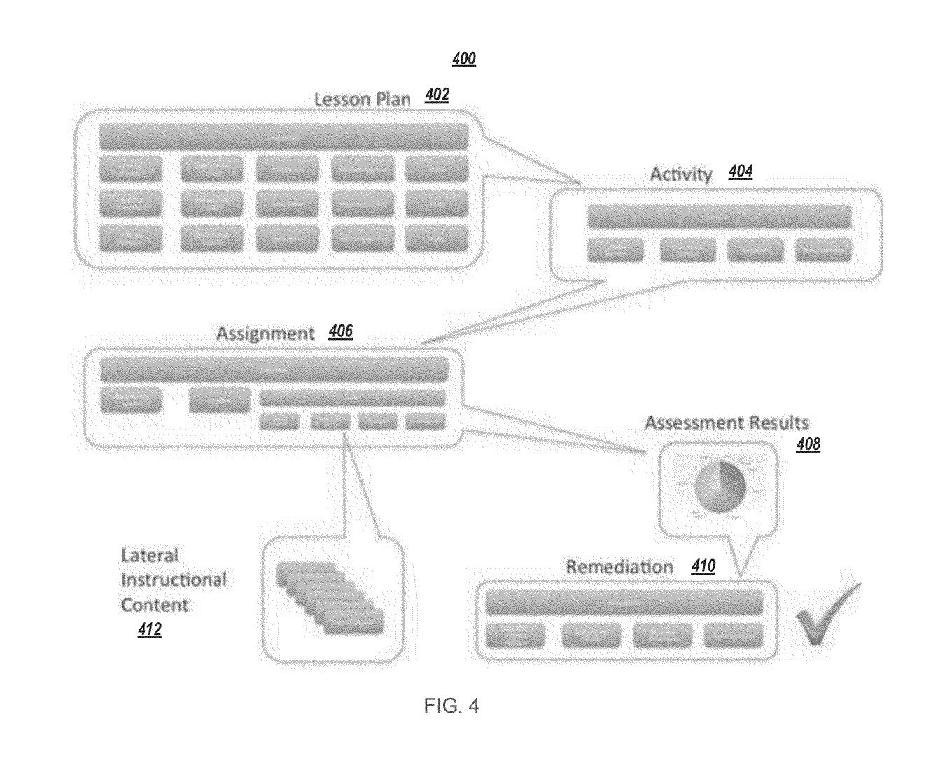

FIG. 4 depicts the overall structure of an educational platform 400. Educational platform 400, which is highly customized for each learner using the educational platform, includes a lesson plan 402, which includes several activities. For instance, a lesson plan 402 for an astronomy course may include several modules of activities. For example, an astronomy course may include an activity on the solar system. Each activity 404 may in turn comprise several different assignments 406. For example, the solar system module consists of several different assignments such as lessons on each of the different planets of the solar system. Each of these assignments 406 may include a core curriculum content item associated with an assessment tied to the assignment. For each core curriculum item in the assignment, there is also lateral instructional content 412, also referred to as supplemental educational content. Assessment generation engine 126 of FIG. 1 can generate an assessment from each of these content items, whether it be a core curriculum item or a supplemental educational item. Assessment generation engine 126 may be configured to score assessments that are completed by learners and generate assessment results 408 for each of these scored assessments. Based upon the results of each assessment, an assessment report and confidence report is generated by assessment generation engine 126 and confidence based assessment engine 128 of FIG. 1. These reports, which server 102 may transmit to parent and teacher devices, provide remediation suggestions 410. Server 102 may also be configured to analyze assessment results 408 to generate remediation options 410 to recommend content based on the assessment results 408 as remediation options 410, such as communicating with another learner who performed much better on the same test and recommending other remedial content to the learner.

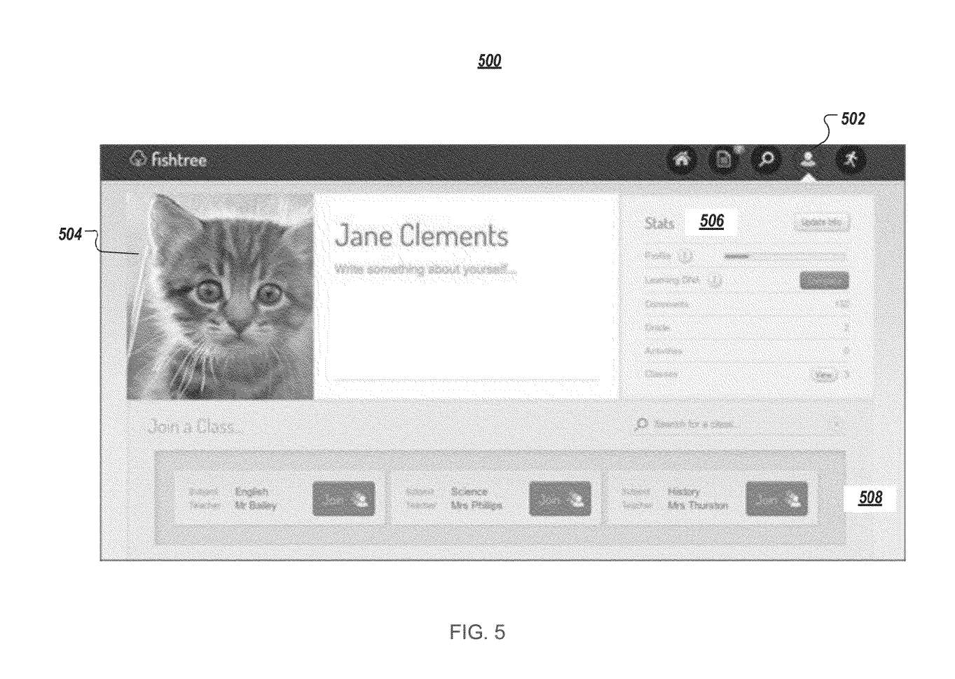

FIG. 5 illustrates an exemplary screenshot of learner device screen displaying a user profile screen 500. Education platform server 102 may render the display of such a profile screen upon user login. In another implementation, server 102 generates user profile screen 500 for display on the display screen of the learner device once user profile icon 502 is selected from a dashboard of the education platform. User profile screen includes a picture 504 of the learner which can be any picture or avatar of the learner that the learner decides to upload. User profile screen 500 may also include user profile data 506 such as the learning preference information (also referred to as Learning DNA), the learner's grade, the amount of activities the learner has participated in, and the number of classes that the learner is currently enrolled in. User profile screen 500 may also include a display of the listings of the classes 508 that the learner is enrolled in. User selection of a class icon 508 from the user profile screen 500 enables the learner to enter the virtual page or virtual pin board for that class.

FIG. 6 illustrates an exemplary screenshot of learner device screen 600 displaying a learner registration survey 602. User selection of the Learning DNA button on user profile screen 500 instructs server 102 to display screen 600 prompting the learner to answer personal preference information into the learner device. Registration survey 602 includes several answer choices 604a, 604b, 604c, and 604d, that the user can select from to specify his personal preferences based on which the user experience of the educational platform will be customized.

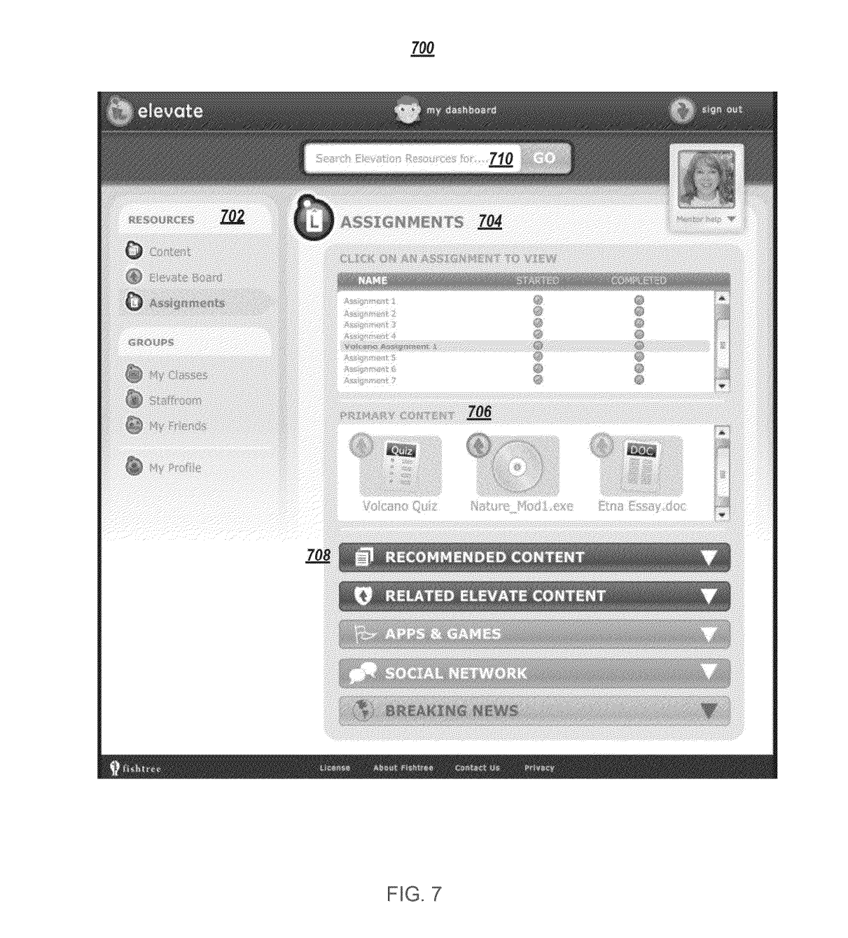

FIG. 7 illustrates an exemplary screenshot of learner device screen displaying a dashboard 700 of the educational platform customized for the learner associated with the learner device. Dashboard 700 includes navigation options 702, which when selected, cause educational platform server 102 to display different pages on dashboard 700. In the example depicted in FIG. 7, the assignment option is selected and therefore, assignments page 704 is displayed on dashboard 700. When a learner inputs a search string into search bar 710, educational content, or assignments, are searched across multiple databases and retrieved for display in assignments section 704. Upon user selection of a particular assignment in assignment section 704, server 102 displays the various items (core curriculum content items, supplemental educational content items, and assessments generated from the content items by assessment generation engine 126) for that particular assignment. Dashboard 700 also includes display of other options such as additional recommended content 708, related content, applications and games option, social network integration option, and a breaking news option.

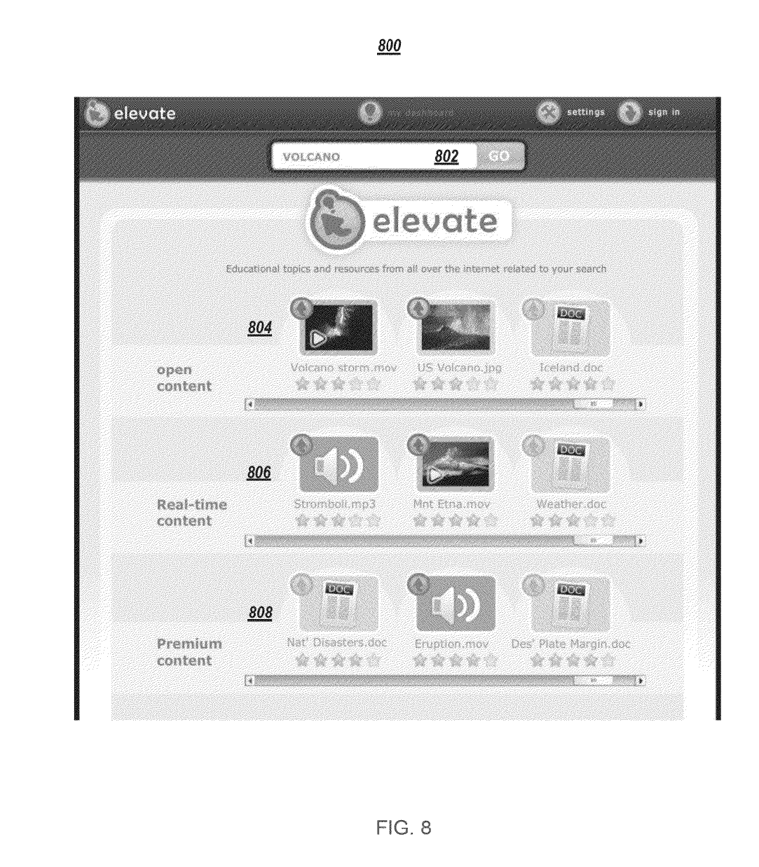

FIG. 8 illustrates an exemplary screenshot of learner device screen 800 displaying several types of content identified from a search conducted by the learner. Content screen 800 is displayed upon user selection of the related content option from options 708 displayed in dashboard 700 of FIG. 7. Content screen 800 displays content that is linked to the core curriculum content that results when content databases are searched using learner input search string in search bar 810. Content screen 800 includes listings of open content 804, listings of real-time content 806, and listings of premium content 808. Each of these listings is identified by search and filter engine 122 based on at least the input search string in search bar 802. In addition, each of the content items listings may be displayed with a rating. A learner may be allowed to modify the rating on content screen 800, through his learner device.

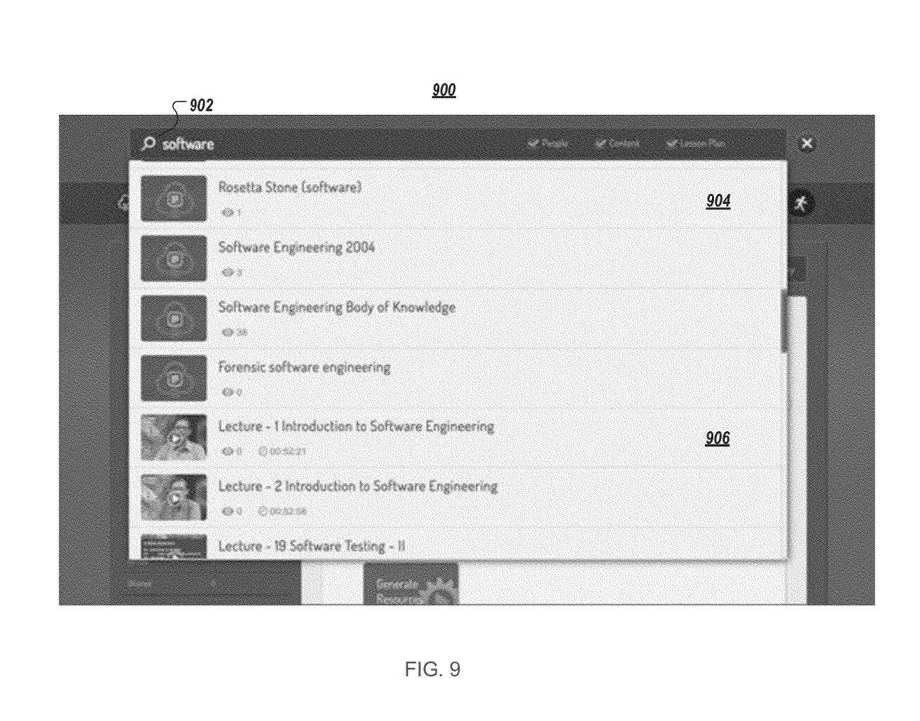

FIG. 9 illustrates an exemplary screenshot of learner device screen 900 displaying search results for content based on an input search string. Learner device screen 900 is similar to screen 800 in that they both display content listings resulting from an input search string. However, learner device screen 900 recommends content listings such as content listings 904 and 906 in a dropdown menu tied to the search bar 902. As soon as a learner inputs a search string or a partial search string into search bar 902, server 102 generates content listings that match the input search string, learner user profile preferences, and learner's learning style preferences and displays these content listings in the dropdown menu. Search and filter engine 122 may rank the content listings results based on the number of parameters that each content listing matches against the learner's user profile and learning preference style.

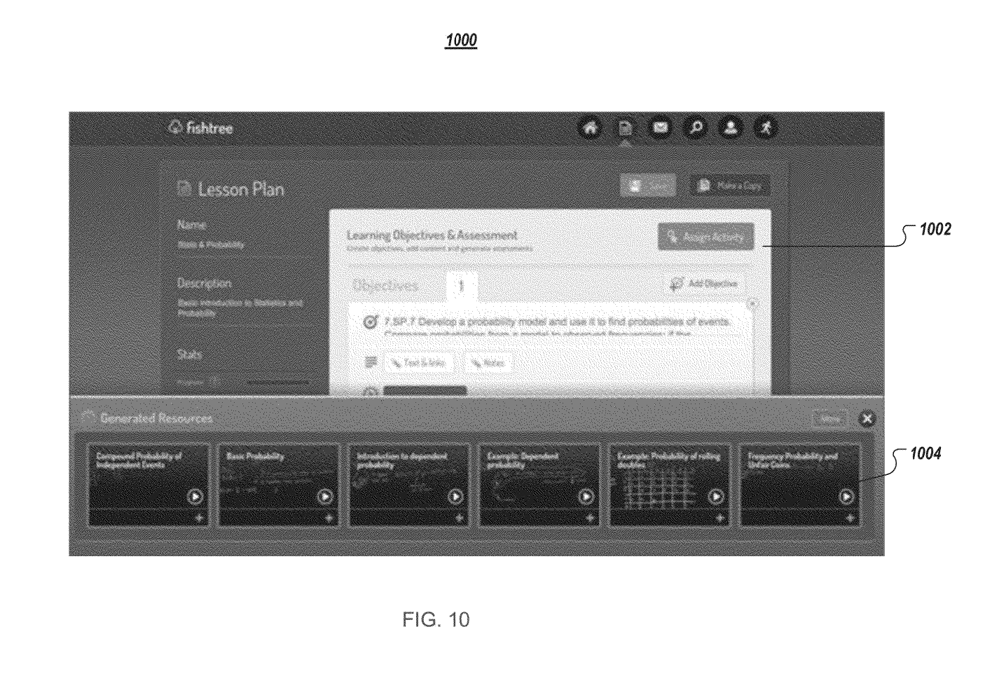

FIG. 10 illustrates an exemplary screenshot of learner device screen 1000 displaying educational content recommended to a learner that is in accordance with a core curriculum standard. Server 102 may be configured to display suggested lesson plans in line with core curriculum standard based on an input keyword search. Screen 1000 illustrates such a suggested lesson plan that results when the user searches for the input string “probability.” Server 102 identifies all core curriculum content on probability that are in compliance with an educational standard and creates a lesson plan based on such content. A dashboard 10002 displaying such a lesson plan is displayed on screen 1000. In addition to displaying lesson plan materials that are part of the core curriculum, server 102 also searches and finds additional supplemental content listings from content databases based on the input search string that are in compliance with the educational standard and meet the learner's learning style and user profile settings. Such content listings are displayed in an overlay 1004. Selection of one of these content items will display the content item on the display screen of the learner device.

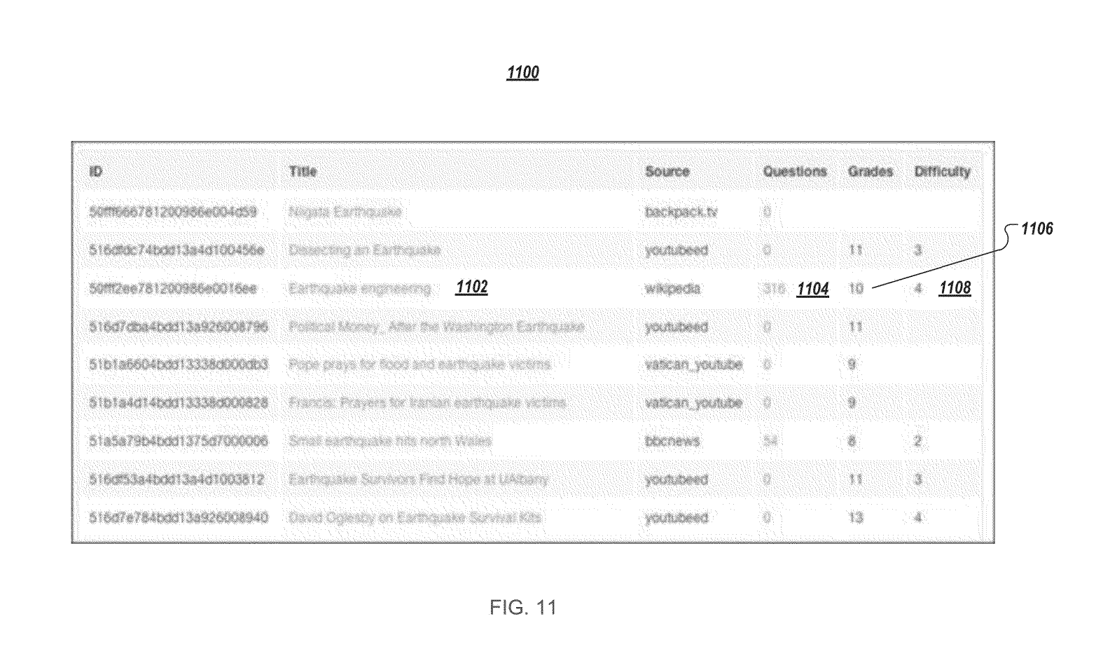

FIG. 11 illustrates a diagram of a table 1100 listing the difficulty of each content source. The text leveling engine 134 parses through content items to identify the grade level and difficulty of each educational content item. Once text leveling engine 134 has determined the difficulty level of each content item, it may store such information in a table such as table 1100 which is maintained in a database such as database 140 of FIG. 1. Each entry in table 1100 includes a title 1102 of each piece of content item, an electronic identifier for the content item, a source of the content item, the number of questions 1104 for an assessment that the assessment generation engine 126 has created from that content item, if any, the grade level 1106 and difficulty level 1108 that text leveling engine 134 has determined for that particular content item. Such information is maintained in table 1100 once server 102 obtains and processes new pieces of educational content. Storing such information allows in a database for each retrieved content item allows server 102 to later access such data for another learner or for later use for the same learner for whom the content was initially retrieved.

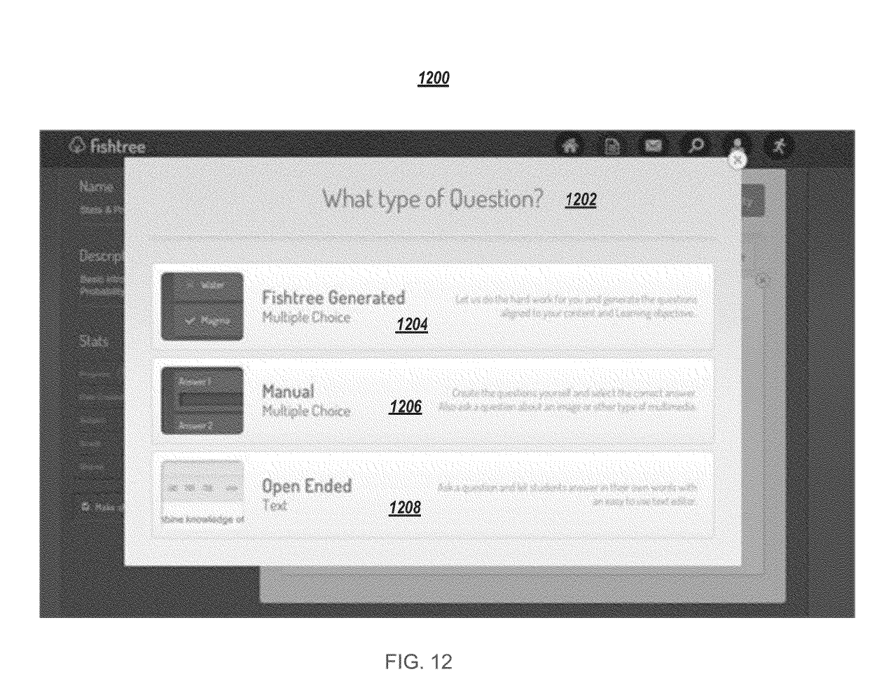

FIG. 12 illustrates an exemplary screenshot of learner device screen 1200 displaying a registration screen 1202 prompting a learner to select an interactivity format for an assessment. Registration engine 124 creates such a survey to learn the learning style of a particular user. Registration screen 1202 prompts a learner associated with the learner device screen 1200 to select what format of assessments the learner prefers to participate in. Options 1204, 1206, and 1208 allow the learner to select from an automatically generation multiple choice assessment, a manual multiple choice option wherein a user manually creates the questions, and an open ended format where the learner can answer a question in an open ended prose format, respectively. Upon user selection of option 1206 for manually generated multiple choice assessments, server 102 allows either a learner, teacher, or parent to generate questions based on a particular content item. Server 102 may generate answer choice to the question using text leveling engine 134 and assessment generation engine 126. In another implementation, the user who has generated the question may be allowed to generate the answer choices himself. Upon user selection of option 1208 to enter open ended answers to an assessment, assessment generation engine 126 generates an assessment questions without generating the answers. The user is allowed to type out the answer in a text box and the user response text is transmitted to a teacher device or parent device for correction. In another implementation, server 102 may employ natural language processing algorithms to score the open ended response and determine the score automatically.

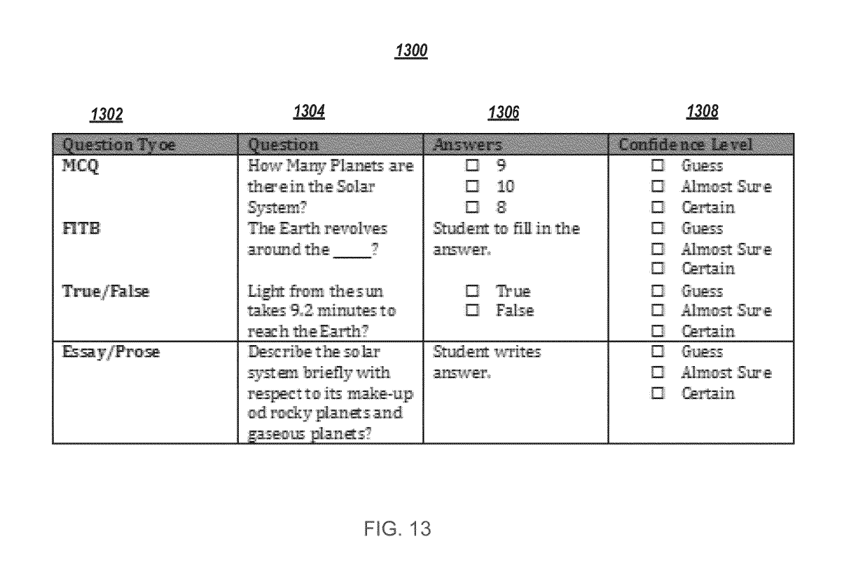

FIG. 13 illustrates a table 1300 displaying an assessment generated by the educational platform server. Table 1300 includes assessment questions that assessment generation engine has created from educational content items. Table 1300 identifies the question type 1302 or interactivity format for each question 1304 (i.e., multiple choice questions, fill in the blank questions, true/false questions, and open ended essay questions. Table 1300 also lists the answer choices 1306 generated by assessment generation engine 126 for each question 1304. Table 1300 also includes answer choices 1306 for confidence level questions associated with each question of questions 1304. Assessment generation engine 126 generates an assessment from questions listed in table 1300 matching the interactivity format that a learner has identified as his preference.

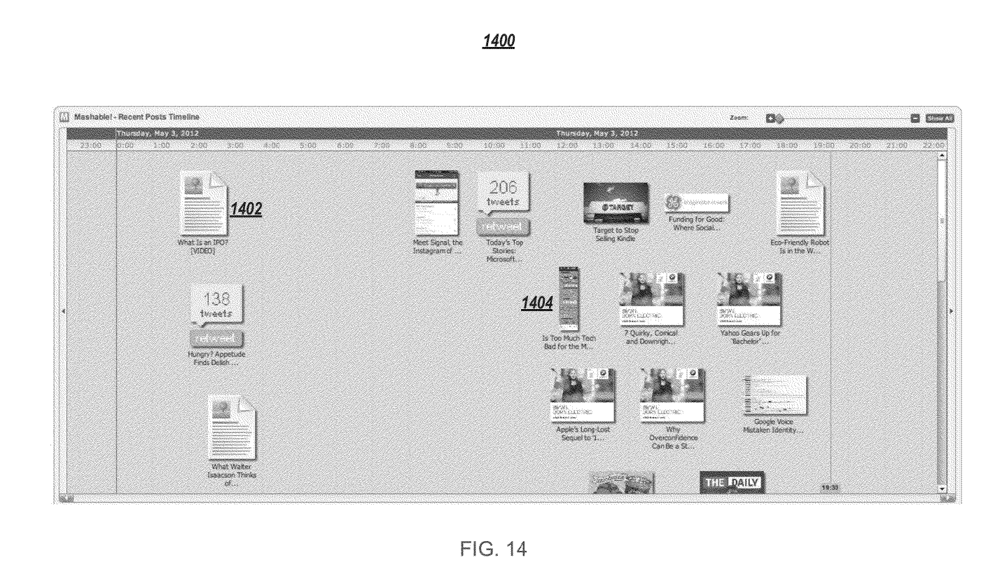

FIG. 14 illustrates an exemplary screenshot of learner device screen displaying a timeline 1400 of the learning activity for a particular learner. Timeline 1400 may include all past educational events that a learner has been engaged in. For instance, timeline 1400 shows that the learner has watched video titled “What is an IPO” on May 3, 2012 with timeline entry 1402. Similarly, timeline entry 1404 indicates that the learner associated with timeline 1400 has read an article on May 3, 2012. Every activity that a learner performs may be time logged and charted on timeline 1400. Timeline 1400 may be a permanent record of activity and a tool for tracking learner progress. Learner timelines such as timeline 1400 may be viewed by parents and teachers to track the progress of a student with respect to the curriculum for a lesson or lessons. Timeline 1400 may also be shared with other users of the educational platform at the learner's discretion. A learner may edit, through a learner device, items that are displayed in his timeline.

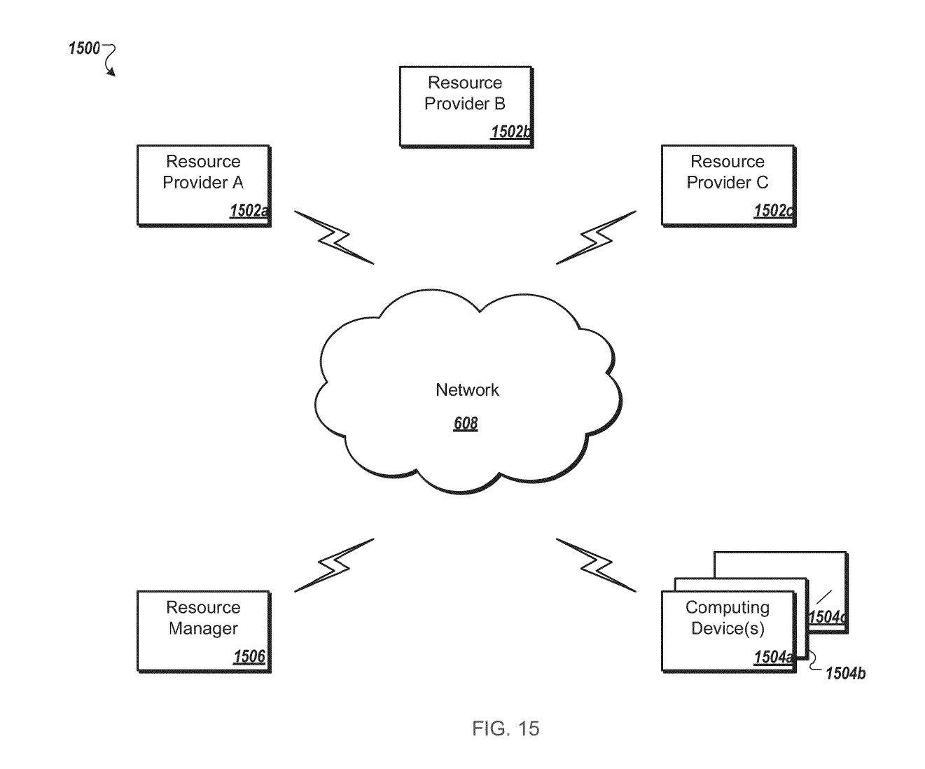

As shown in FIG. 15, an implementation of a network environment 1500 for use in facilitating operation of system 100 as described in FIG. 1 is shown and described. In brief overview, referring now to FIG. 15, a block diagram of an exemplary cloud computing environment 1500 is shown and described. The cloud computing environment 1500 may include one or more resource providers 1502a, 1502b, 1502c (collectively, 1502). Each resource provider 1502 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1502 may be connected to any other resource provider 1502 in the cloud computing environment 1500. In some implementations, the resource providers 1502 may be connected over a computer network 1508. Each resource provider 1502 may be connected to one or more computing device 1504a, 1504b, 1504c (collectively, 1504), over the computer network 1508.

The cloud computing environment 1500 may include a resource manager 1506. The resource manager 1506 may be connected to the resource providers 1502 and the computing devices 1504 over the computer network 1508. In some implementations, the resource manager 1506 may facilitate the provision of computing resources by one or more resource providers 1502 to one or more computing devices 1504. The resource manager 1506 may receive a request for a computing resource from a particular computing device 1504. The resource manager 1506 may identify one or more resource providers 1502 capable of providing the computing resource requested by the computing device 1504. The resource manager 1506 may select a resource provider 1502 to provide the computing resource. The resource manager 1506 may facilitate a connection between the resource provider 1502 and a particular computing device 1504. In some implementations, the resource manager 1506 may establish a connection between a particular resource provider 1502 and a particular computing device 1504. In some implementations, the resource manager 1506 may redirect a particular computing device 1504 to a particular resource provider 1502 with the requested computing resource.

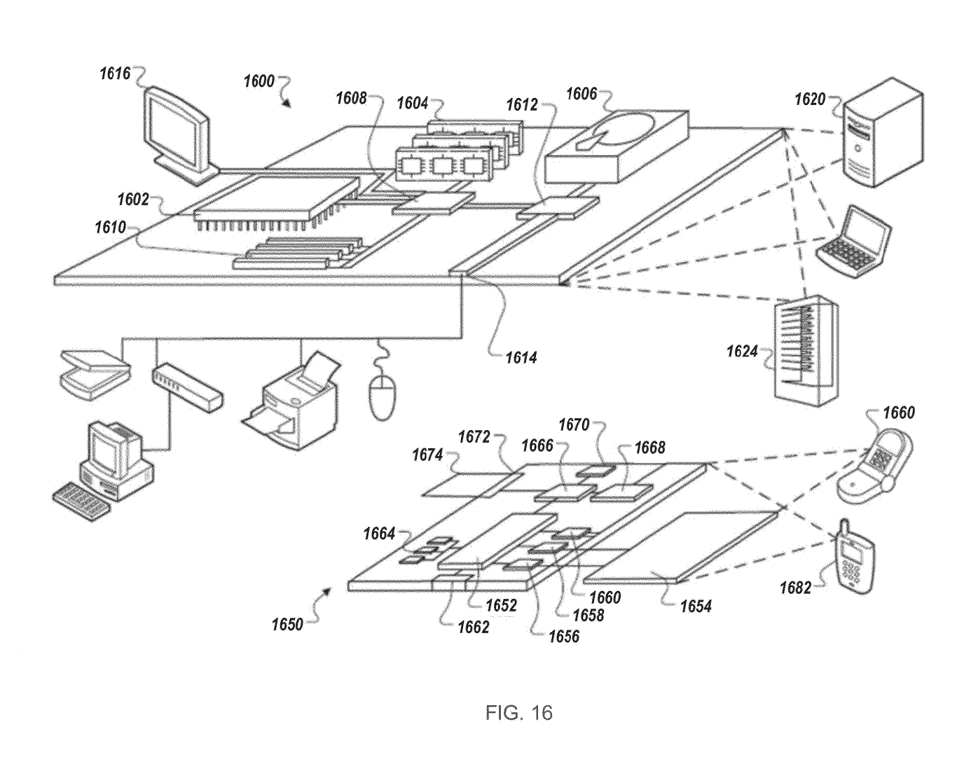

FIG. 16 shows an example of a computing device 1600 and a mobile computing device 1650 that can be used to implement the techniques described in this disclosure. The computing device 1600 is intended to represent various forms of digital computers, such as laptops, desktops, workstations, personal digital assistants, servers, blade servers, mainframes, and other appropriate computers. The mobile computing device 1650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1600 includes a processor 1602, a memory 1604, a storage device 1606, a high-speed interface 1608 connecting to the memory 1604 and multiple high-speed expansion ports 1610, and a low-speed interface 1612 connecting to a low-speed expansion port 1614 and the storage device 1606. Each of the processor 1602, the memory 1604, the storage device 1606, the high-speed interface 1608, the high-speed expansion ports 1610, and the low-speed interface 1612, are interconnected using various busses, and may be mounted on a common motherboard or in other manners as appropriate. The processor 1602 can process instructions for execution within the computing device 1600, including instructions stored in the memory 1604 or on the storage device 1606 to display graphical information for a GUI on an external input/output device, such as a display 1616 coupled to the high-speed interface 1608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1604 stores information within the computing device 1600. In some implementations, the memory 1604 is a volatile memory unit or units. In some implementations, the memory 1604 is a non-volatile memory unit or units. The memory 1604 may also be another form of computer-readable medium, such as a magnetic or optical disk.

The storage device 1606 is capable of providing mass storage for the computing device 1600. In some implementations, the storage device 1606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1602), perform one or more methods, such as those described above. The instructions can also be stored by one or more storage devices such as computer- or machine-readable mediums (for example, the memory 1604, the storage device 1606, or memory on the processor 1602).

The high-speed interface 1608 manages bandwidth-intensive operations for the computing device 1600, while the low-speed interface 1612 manages lower bandwidth-intensive operations. Such allocation of functions is an example only. In some implementations, the high-speed interface 1608 is coupled to the memory 1604, the display 1616 (e.g., through a graphics processor or accelerator), and to the high-speed expansion ports 1610, which may accept various expansion cards (not shown). In the implementation, the low-speed interface 1612 is coupled to the storage device 1606 and the low-speed expansion port 1614. The low-speed expansion port 1614, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1600 may be implemented in a number of different forms, as shown in the figure. For example, it may be implemented as a standard server 1620, or multiple times in a group of such servers. In addition, it may be implemented in a personal computer such as a laptop computer 1622. It may also be implemented as part of a rack server system 1624. Alternatively, components from the computing device 1600 may be combined with other components in a mobile device (not shown), such as a mobile computing device 1650. Each of such devices may contain one or more of the computing device 1600 and the mobile computing device 1650, and an entire system may be made up of multiple computing devices communicating with each other.

The mobile computing device 1650 includes a processor 1652, a memory 1664, an input/output device such as a display 1654, a communication interface 1666, and a transceiver 1668, among other components. The mobile computing device 1650 may also be provided with a storage device, such as a micro-drive or other device, to provide additional storage. Each of the processor 1652, the memory 1664, the display 1654, the communication interface 1666, and the transceiver 1668, are interconnected using various buses, and several of the components may be mounted on a common motherboard or in other manners as appropriate.

The processor 1652 can execute instructions within the mobile computing device 1650, including instructions stored in the memory 1664. The processor 1652 may be implemented as a chipset of chips that include separate and multiple analog and digital processors. The processor 1652 may provide, for example, for coordination of the other components of the mobile computing device 1650, such as control of user interfaces, applications run by the mobile computing device 1650, and wireless communication by the mobile computing device 1650.

The processor 1652 may communicate with a user through a control interface 1658 and a display interface 1656 coupled to the display 1654. The display 1654 may be, for example, a TFT (Thin-Film-Transistor Liquid Crystal Display) display or an OLED (Organic Light Emitting Diode) display, or other appropriate display technology. The display interface 1656 may comprise appropriate circuitry for driving the display 1654 to present graphical and other information to a user. The control interface 1658 may receive commands from a user and convert them for submission to the processor 1652. In addition, an external interface 1662 may provide communication with the processor 1652, so as to enable near area communication of the mobile computing device 1650 with other devices. The external interface 1662 may provide, for example, for wired communication in some implementations, or for wireless communication in other implementations, and multiple interfaces may also be used.

The memory 1664 stores information within the mobile computing device 1650. The memory 1664 can be implemented as one or more of a computer-readable medium or media, a volatile memory unit or units, or a non-volatile memory unit or units. An expansion memory 1674 may also be provided and connected to the mobile computing device 1650 through an expansion interface 1672, which may include, for example, a SIMM (Single In Line Memory Module) card interface. The expansion memory 1674 may provide extra storage space for the mobile computing device 1650, or may also store applications or other information for the mobile computing device 1650. Specifically, the expansion memory 1674 may include instructions to carry out or supplement the processes described above, and may include secure information also. Thus, for example, the expansion memory 1674 may be provide as a security module for the mobile computing device 1650, and may be programmed with instructions that permit secure use of the mobile computing device 1650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier, that the instructions, when executed by one or more processing devices (for example, processor 1652), perform one or more methods, such as those described above. The instructions can also be stored by one or more storage devices, such as one or more computer- or machine-readable mediums (for example, the memory 1664, the expansion memory 1674, or memory on the processor 1652). In some implementations, the instructions can be received in a propagated signal, for example, over the transceiver 1668 or the external interface 1662.

The mobile computing device 1650 may communicate wirelessly through the communication interface 1666, which may include digital signal processing circuitry where necessary. The communication interface 1666 may provide for communications under various modes or protocols, such as GSM voice calls (Global System for Mobile communications). SMS (Short Message Service). EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1668 using a radio-frequency. In addition, short-range communication may occur, such as using a Bluetooth®, Wi-Fi™, or other such transceiver (not shown). In addition, a GPS (Global Positioning System) receiver module 1670 may provide additional navigation- and location-related wireless data to the mobile computing device 1650, which may be used as appropriate by applications running on the mobile computing device 1650.

The mobile computing device 1650 may also communicate audibly using an audio codec 1660, which may receive spoken information from a user and convert it to usable digital information. The audio codec 1660 may likewise generate audible sound for a user, such as through a speaker, e.g., in a handset of the mobile computing device 1650. Such sound may include sound from voice telephone calls, may include recorded sound (e.g., voice messages, music files, etc.) and may also include sound generated by applications operating on the mobile computing device 1650.

The mobile computing device 1650 may be implemented in a number of different forms, as shown in the figure. For example, it may be implemented as a cellular telephone 1680. It may also be implemented as part of a smart-phone 1682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for generating a personalized education platform are provided. Having described certain implementations of methods and apparatus for supporting an educational platform that is highly customizable to the needs of each of its learners, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

1. A method for providing educational content to a computing device associated with a user, the method comprising:
receiving, by a processor of the computing device, a request to provide, to a computing device associated with the user, educational content associated with a topic, wherein the request is a member selected from a group consisting of: a search request from the computing device associated with the user, a request from a computing device of a parent of the user to provide educational content associated with a topic to the computing device associated with the user, and a request from a computing device of a teacher of the user to provide educational content associated with a topic to the computing device associated with the user;
identifying, by the processor, at least one of: (i) user profile information associated with the user and/or (ii) learning preference information associated with the user, wherein the learning preference information is based at least in part on information collected from a survey completed by the user,
identifying, by the processor, educational content responsive to the request from a plurality of content sources, wherein the educational content is identified based on at least one of (i) the identified user profile information and/or (ii) the identified learning preference information; and
providing, for display on the computing device associated with the user, the identified educational content.

2. The method of claim 1, further comprising:
receiving, from the computing device associated with the user, a rating for the educational content provided to the computing device associated with the user; and
storing, in a memory of the computing device, the received rating.

3. The method of claim 1, wherein the user profile information includes at least one member selected from a group consisting of: user age, user grade level, user location, user profile data of similar users, time of day the user accesses the educational content, social interactions of the user, user assessment scores, peer to peer interactions, historic educational performance of the user, user interests, user preferred language, and demographic information.

4. The method of claim 1, further comprising:
identifying, by the processor, a user profile of a second user by comparing the user profile information and/or learning preference information of the user and the second user, wherein identifying the educational content is further based at least in part on a content rating provided by a computing device associated with the second user and the user profile of the second user.

5. The method of claim 1, wherein the identified educational content is identified based at least in part on a degree of relation between the educational content and content identified by a computing device associated with the teacher of the user.

6. The method of claim 1, further comprising:
providing, for display on the computing device associated with the user, an assessment, wherein the assessment is automatically generated by the processor of the computing device based at least in part on the text of the educational content.

7. The method of claim 1, further comprising:
identifying, by the processor, an interactive assessment format based at least in part on (i) user profile information from a user profile associated with the user and/or (ii) learning preference information associated with the user,
generating, by the processor, an assessment in the identified interactive assessment format; and
providing, for display on a computing device associated with the user, the assessment in the identified interactive assessment format.

8. The method of claim 1, wherein the educational content is identified further based at least in part on content identified by the teacher of the user.

9. A system for providing educational content to a computing device associated with a user, the system comprising:
a processor,
a memory having instructions stored thereon, wherein the instructions, when executed, cause the processor to:
receive a request, to provide to a computing device associated with the user, educational content associated with a topic, wherein the request is a member selected from a group consisting of: a search request from the computing device associated with the user, a request from a computing device of a parent of the user to provide educational content associated with a topic to the computing device associated with the user, and a request from a computing device of a teacher of the user to provide educational content associated with a topic to the computing device associated with the user;
identify at least one of: (i) user profile information associated with the user and/or (ii) learning preference information associated with the user, wherein the learning preference information is based at least in part on information collected from a survey completed by the user,
identify educational content responsive to the request from a plurality of content sources, wherein the educational content is identified based on at least one of (i) the identified user profiled information and/or (ii) the identified learning preference information; and
provide, for display on the computing device associated with the user, the identified educational content.

10. The system of claim 9, wherein the instructions stored on the memory, when executed, cause the processor to further:
receive, from the computing device associated with the user, a rating for the educational content provided to the computing device associated with the user; and
store the received rating in the memory.

11. The system of claim 9, wherein the user profile information includes at least one member selected from a group consisting of: user age, user grade level, user location, user profile data of similar users, time of day the user accesses the educational content, social interactions of the user, user assessment scores, peer to peer interactions, historic educational performance of the user, user interests, user preferred language, and demographic information.

12. The system of claim 9, wherein the instructions stored on the memory, when executed, cause the processor to further:
identify a user profile of a second user by comparing the user profile information and/or learning preference information of the user and the second user, wherein identifying the educational content is further based at least in part on content ratings provided by a computing device associated with the second user and the user profile of the second user.

13. The system of claim 9, wherein the identified educational content is identified based at least in part on a degree of relation between the educational content and content identified by a computing device associated with the teacher of the user.

14. The system of claim 9, wherein the instructions stored on the memory, when executed, cause the processor to further:
provide, for display on the computing device associated with the user, an assessment, wherein the assessment is automatically generated by the processor of the computing device based at least in part on the text of the educational content.

15. The system of claim 9, wherein the instructions stored on the memory, when executed, cause the processor to further:
identify an interactive assessment format based at least in part on (i) user profile information from a user profile associated with the user and/or (ii) learning preference information associated with the user;
generating an assessment in the identified interactive assessment format; and
provide, for display on a computing device associated with the user, the assessment in the identified interactive assessment format.

16. The system of claim 9, wherein the educational content is identified further based at least in part on content identified by the teacher of the user.

17. A method for conducting an educational assessment, the method comprising:
retrieving, by a processor of a computing device, educational content from a content database;
identifying, by the processor, an interactive assessment format based at least in part on (i) user profile information from a user profile associated with the user and/or (ii) learning preference information associated with the user, wherein the learning preference information is based at least in part on information collected from a survey completed by the user,
generating, by the processor, an assessment in the identified interactive assessment format; and
providing, for display on a computing device associated with the user, the assessment.

18. The method of claim 17, further comprising:
receiving, by the processor, from the computing device associated with the user, (i) one or more responses associated with the assessment and (ii) confidence data for the one or more responses;
determining, by the processor, a report based on the one or more responses and/or the confidence data; and
providing, by the processor, the report to at least one of (i) a computing device associated with a parent of the user and (ii) a computing device associated with a teacher of the user.

19. The method of claim 18, wherein the report includes an assessment report and a confidence report, wherein the assessment report is based at least in part on the one or more responses and the confidence report is based at least in part on the confidence data.

20. The method of claim 18, wherein the report identifies at least one of: (i) areas of improvement by the user and (ii) areas in need of improvement by the user.

21. The method of claim 17, wherein the assessment is a member selected from a group consisting of: a true/false quiz, a crossword puzzle, a game, a fill-in-the-blank quiz, and an open ended text quiz.

22. A system for conducting an educational assessment, the system comprising:
a processor,
a memory having instructions stored thereon, wherein the instructions, when executed, cause the processor to:
retrieve educational content from a content database;
identify an interactive assessment format based at least in part on (i) user profile information from a user profile associated with a user and/or (ii) learning preference information associated with the user, wherein the learning preference information is based at least in part on information collected from a survey completed by the user;
generate an assessment in the identified interactive assessment format; and
provide, for display on a computing device associated with the user, the assessment.

23. The system of claim 22, wherein the instructions stored on the memory, when executed, cause the processor to further:
receive from the computing device associated with the user, (i) one or more responses associated with the assessment and (ii) confidence data for the one or more responses;
determine a report based on the one or more responses and/or the confidence data; and
provide the report to at least one of (i) a computing device associated with a parent of the user and (ii) a computing device associated with a teacher of the user.

24. The system of claim 23, wherein the report includes an assessment report and a confidence report, wherein the assessment report is based at least in part on the one or more responses and the confidence report is based at least in part on the confidence data.

25. The system of claim 23, wherein the report identifies at least one of: (i) areas of improvement by the user and (ii) areas in need of improvement by the user.

26. The system of claim 22, wherein the assessment is a member selected from a group consisting of: a true/false quiz, a crossword puzzle, a game, a fill-in-the-blank quiz, and an open ended text quiz.

27. A method for recommending customized educational content, the method comprising:
identifying, by a processor of a computing device, a plurality of user profiles, wherein each of the plurality of user profiles is associated with a learner using an educational platform;
generating, by the processor, a combined class profile based on the plurality of user profiles; and
providing, by the processor, a recommendation for educational content to a teacher based at least in part on (i) the combined class profile and (ii) a lesson topic, wherein the lesson topic is identified by the processor from a curriculum standard.

28. The method of claim 27, further comprising:
automatically generating, by the processor, an assessment by analyzing the recommended educational content;
providing, by the processor, the assessment and the recommended educational content to a computing device associated with a learner using the educational platform;
determining, by the processor, an assessment outcome, wherein the assessment outcome is based on performance of the learner on the assessment;
determining, by the processor, an efficacy score for the recommended educational content based on the assessment outcome; and
storing the efficacy score, wherein at least one of the efficacy score, assessment outcome, and one or more of the plurality of user profiles are used to identify future recommendations for educational content to the teacher.
